(19) United States
(12) Patent Application Publication
(10) Pub. No.: US 2019/0253372 A1
(43) Pub. Date: Aug. 15, 2019

(54) METHODS, SYSTEMS, APPARATUSES AND DEVICES FOR FACILITATING PEER-TO-PEER SHARING OF AT LEAST ONE IMAGE

(71) Applicant: Bryan Edward Long, Carlsbad, CA (US)

(72) Inventor: Bryan Edward Long, Carlsbad, CA (US)

(21) Appl. No.: 16/277,318

(22) Filed: Feb. 15, 2019

Related U.S. Application Data
(60) Provisional application No. 62/631,347, filed on Feb. 15, 2018.

(51) Int. Cl. H04L 12/58; H04W 4/029; H04W 4/18; H04L 29/08

(52) U.S. Cl. CPC H04L 51/10; H04W 4/029; G06Q 20/123; H04L 67/1068; H04L 67/20; H04W 4/185

(57) ABSTRACT

A system for facilitating peer-to-peer sharing of at least one image is disclosed. The system may include a communication device configured to receive the at least one image captured by a first user device along with an orientation and a location of the first user device. Further, the communication device may be configured to receive a location of a second user device. Further, the communication device may be configured to send a notification to the second user device based on matching of a coverage area with the location of the second user device. Further, the system may include a processing device configured to determine the coverage area based on a field of view, the orientation and the location of the first user device. Further, the processing device may be configured to match the coverage area with the location of the second user device.

The current application claims a priority to the U.S. Provisional Patent application Ser. No. 62/631,347 filed on Feb. 15, 2018.

### FIELD OF THE INVENTION

Generally, the present disclosure relates to the field of data processing. More specifically, the present disclosure relates to methods, systems, apparatuses and devices for facilitating peer-to-peer sharing of at least one image.

### BACKGROUND OF THE INVENTION

The grown abundance of recording devices has eased the process of capturing and creation of content. Further, due to a growth in the number of recording, and viewing devices, and with the improvement in Internet services, the transfer of data and content worldwide has become possible, and easier. Additionally, if content, such as multimedia content is shared on public platforms such as social media, individuals featuring in the content such as images may be notified. Further, additional supporting information such as the location of an individual may also be retrieved through appropriate user devices, which may be included and shared along with the captured content.

However, existing systems may not be able to detect when an individual may be captured and recorded in content based on comparing a location of the individual and the orientation data of a capturing or recording device that may be used to capture and/or the individual. Further, existing systems may not include the feature of anonymous, crowdsourced peer to peer sharing of content.

Further, existing techniques for sharing of content are deficient with regard to several aspects. For instance, current technologies do not notify a user based on the preferences set by the user with respect to the content that may have been captured while recording/photographing the user.

Furthermore, existing technologies may not alert an individual of a capturing event, such as a capturing of an image, or video capturing the individual based on orientation/location matching, image analysis etc.

Therefore, there is a need for improved methods, systems, apparatuses and devices for facilitating peer-to-peer sharing of at least one image that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating peer-to-peer sharing of at least one image, in accordance with some embodiments. Accordingly, the method may include a step of receiving, using a communication device, the at least one image captured by a first user device along with an orientation and a location of the first user device. Further, the method may include a step of receiving, using the communication device, a location of a second user device. Further, the method may include a step of determining, using a processing device, a coverage area based on a field of view, the orientation and the location of the first user device. Further, the method may include a step of matching, using the processing device, the coverage area with the location of the second user device. Further, the method may include a step of sending, using the communication device, a notification to the second user device based on the matching.

Further disclosed herein is a system for facilitating peer-to-peer sharing of at least one image, in accordance with some embodiments. Accordingly, the system may include a communication device configured to receive the at least one image captured by a first user device along with an orientation and a location of the first user device. Further, the communication device may be configured to receive a location of a second user device. Further, the communication device may be configured to send a notification to the second user device based on matching of a coverage area with the location of the second user device. Further, the system may include a processing device configured to determine the coverage area based on a field of view, the orientation and the location of the first user device. Further, the processing device may be configured to match the coverage area with the location of the second user device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a system of facilitating peer-to-peer sharing of at least one image, in accordance with some embodiments.

FIG. 3 is a flowchart of a method of facilitating peer-to-peer sharing of at least one image, in accordance with some embodiments.

FIG. 4 is a flowchart describing a method to facilitate the capturing and anonymous sharing of content, in accordance with some embodiments.

FIG. 5 is a flowchart describing a method to facilitate the capturing and anonymous sharing of captured content, including sharing the captured content through a unique code, in accordance with some embodiments.

FIG. 6 is an exemplary embodiment of a system to facilitate peer-to-peer sharing of at least one image, where a first user may capture content including a second user, in accordance with some embodiments.

FIG. 7 is an exemplary embodiment of a system to facilitate peer-to-peer sharing of at least one image, showing a second user receiving a notification related to captured content including the second user, in accordance with some embodiments.

FIG. 8 is an exemplary embodiment of a system to facilitate peer-to-peer sharing of at least one image, where a first user and a third user may capture content including a second user, in accordance with some embodiments.

FIG. 9 is an exemplary embodiment of a system to facilitate peer-to-peer sharing of at least one image, showing a second user receiving a notification, in accordance with some embodiments.

FIG. 10 is a user device with a user interface of a smartphone application, in accordance with some embodiments.

FIG. 11 is a user device with a user interface of a smartphone application, in accordance with some embodiments.

FIG. 12 is a user device with a user interface of a smartphone application, in accordance with some embodiments.

FIG. 13 is a user device with a user interface of a smartphone application, in accordance with some embodiments.

FIG. 14 is a user device with a user interface of a smartphone application, in accordance with some embodiments.

FIG. 15 is a user device with a user interface of a smartphone application, in accordance with some embodiments.

FIG. 16 is a user device with a user interface of a smartphone application, in accordance with some embodiments.

FIG. 17 is a snapshot of a user interface of a smartphone application, in accordance with an exemplary embodiment.

FIG. 18 is a snapshot of a user interface of a smartphone application, in accordance with an exemplary embodiment.

FIG. 19 is a snapshot of a user interface of a smartphone application, in accordance with an exemplary embodiment.

FIG. 20 is a snapshot of a user interface of a smartphone application, in accordance with an exemplary embodiment.

FIG. 21 is a snapshot of a user interface of a smartphone application, in accordance with an exemplary embodiment.

FIG. 22 is a snapshot of a user interface of a smartphone application, in accordance with an exemplary embodiment.

FIG. 23 is a snapshot of a user interface of a smartphone application, in accordance with an exemplary embodiment.

FIG. 24 is a snapshot of a user interface of a smartphone application, in accordance with an exemplary embodiment.

FIG. 25 is a snapshot of a user interface of a smartphone application, in accordance with an exemplary embodiment.

FIG. 26 is a snapshot of a user interface of a smartphone application, in accordance with an exemplary embodiment.

FIG. 27 is a snapshot of a user interface of a smartphone application, in accordance with an exemplary embodiment.

FIG. 28 is a snapshot of a user interface of a smartphone application, in accordance with an exemplary embodiment.

FIG. 29 is a snapshot of a user interface of a smartphone application, in accordance with an exemplary embodiment.

FIG. 30 is a snapshot of a user interface of a smartphone application, in accordance with an exemplary embodiment.

FIG. 31 is a snapshot of a user interface of a smartphone application, in accordance with an exemplary embodiment.

FIG. 32 is a snapshot of a user interface of a smartphone application, in accordance with an exemplary embodiment.

FIG. 33 is a snapshot of a user interface of a smartphone application, in accordance with an exemplary embodiment.

FIG. 34 is a snapshot of a user interface of a smartphone application, in accordance with an exemplary embodiment.

FIG. 35 is a snapshot of a user interface of a smartphone application, in accordance with an exemplary embodiment.

FIG. 36 is a snapshot of a user interface of a smartphone application, in accordance with an exemplary embodiment.

FIG. 37 is a snapshot of a user interface of a smartphone application, in accordance with an exemplary embodiment.

FIG. 38 is a snapshot of a user interface of a smartphone application, in accordance with an exemplary embodiment.

FIG. 39 is a snapshot of a user interface of a smartphone application, in accordance with an exemplary embodiment.

FIG. 40 is a snapshot of a user interface of a smartphone application, in accordance with an exemplary embodiment.

FIG. 41 is a snapshot of a user interface of a smartphone application, in accordance with an exemplary embodiment.

FIG. 42 is a snapshot of a user interface of a smartphone application, in accordance with an exemplary embodiment.

FIG. 43 is a snapshot of a user interface of a smartphone application, in accordance with an exemplary embodiment.

FIG. 44 is a snapshot of a user interface of a smartphone application, in accordance with an exemplary embodiment.

FIG. 45 is a snapshot of a user interface of a smartphone application, in accordance with an exemplary embodiment.

FIG. 46 shows a printer printing a physical card, including a unique code corresponding to an image, in accordance with some embodiments.

FIG. 47 shows the printer, along with the physical card, including the unique code corresponding to the image, in accordance with some embodiments.

FIG. 48 shows a close up view of the physical card, including the unique code corresponding to the image, in accordance with some embodiments.

FIG. 49 is a snapshot of a user interface of a smartphone application to scan a unique code, in accordance with an exemplary embodiment.

FIG. 50 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of peer-to-peer sharing of at least one image, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

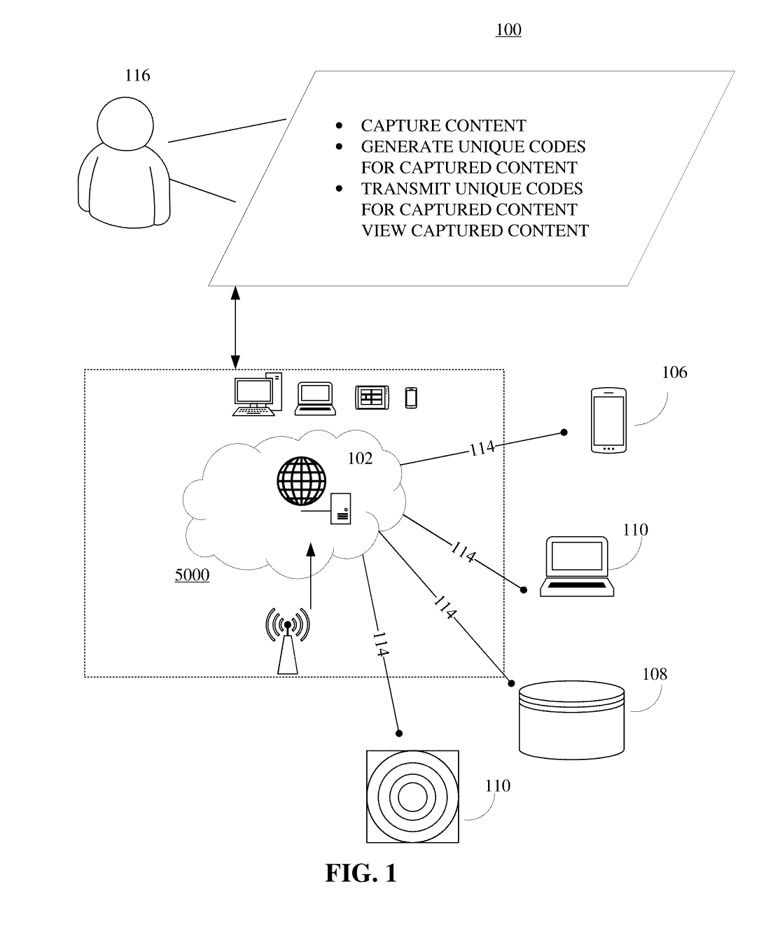

FIG. 1 is an illustration of an online platform 100 consistent with various embodiments of the present disclosure. By way of non-limiting example, the online platform 100 to facilitate peer-to-peer sharing of at least one image may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 and over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 5000.

According to some embodiments, the online platform 100 may be configured to communicate with a system to facilitate the capturing and anonymous sharing of content. Content may include pictures or video clips with or without audio, or audio clips.

Accordingly, the system may include a user device that a user may use to access the online platform 100 and to capture the content. The user device may be a mobile device such as, but not limited to, a smartphone, or a computer tablet, a computing device like a personal computer, or a laptop, or a wearable device configured to capture and record content such as smart glasses, or a smartwatch. The user device may include a communication device configured to communicate over a communication network such as, but not limited to, a cellular network, a satellite network, a personal area network, Bluetooth, Internet and so on. Further, the user device may include sensors that may be used to capture the content, such as a camera and microphone, location sensors such as GPS, and additional sensors to record and monitor the orientation, and direction of the user and the user device such as a gyroscope, and accelerometer.

Further, the system may allow users to register and create user profiles on the online platform 100. Accordingly, the user profiles may include information about the name, age, gender, location, and so on about the users.

A user may make use of a user device to capture the content. The content may include still images, videos accompanied by audio, videos without audio, and audio clips. Accordingly, the user may make use of a user device to capture and record the content. While the user may be capturing the content through the user device, parameters such as the location, the direction, and orientation of the user device while capturing the content may be monitored. The parameters may be constantly monitored and analyzed by a processing device to determine whether the user may have captured another user in the content. The location of the other user may be monitored and analyzed against the monitored parameters such as the location, orientation, and direction to determine whether the user may have been captured in any content.

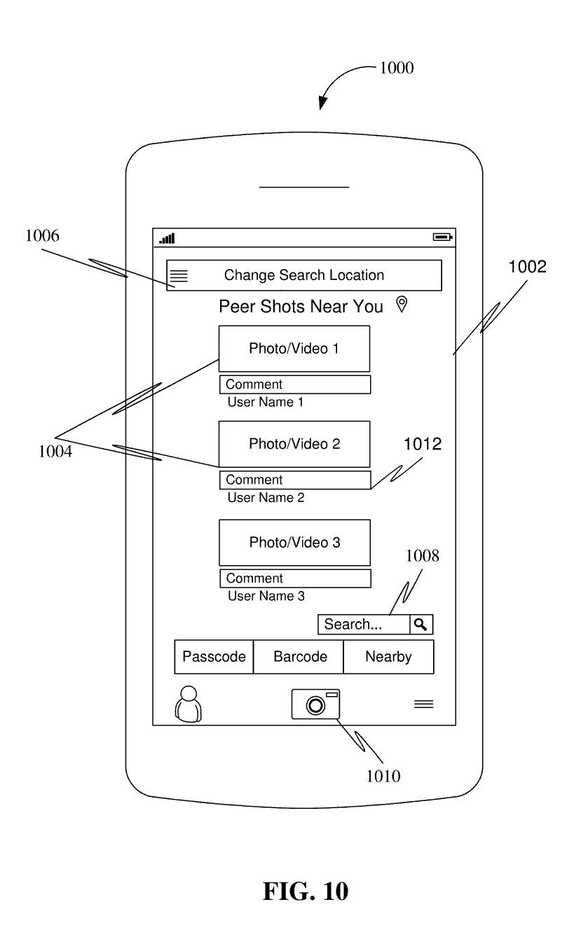

Further, the other user may receive an anonymous notification on the user device notifying that the other user may have been captured in the one or more content. The anonymous notification may not disclose the personal information of the user who may have captured the content. As shown in FIGS. 10-12, the user may choose to accept to save the content in the user device. In an instance, the user may accept to save the content through an input mechanism of the user device. Alternatively, the user may, through the mechanism of the user device, choose not to save the content. Accordingly, the content may be deleted. In an embodiment, the content may also be deleted from the one or more user devices of the user who may have captured the content.

In further embodiments, the user may capture content featuring one or more individuals. The one or more individuals may not have registered on the online platform 100, and as such may not receive a notification notifying the one or more individuals of about the captured content. Accordingly, the user may save the captured content. The captured content may be saved along with the supporting information on a database hosted on the online platform 100. Further, the user may generate a unique code for the captured content. In an instance, the unique code generated may be a barcode, a QR code, an Aztec Code, or any other type of a matrix barcode, or even an alphanumeric passcode. The user may share the one or more unique codes for the captured content with one or more other users of the online platform 100. The one or more users of the online platform 100 may use the one or more unique codes to access the database hosted on the online platform 100 and view the captured content. Further, the user may also share the one or more unique codes with other individuals who may not be registered on the online platform 100, including individuals who may be featured in the captured content, allowing the one or more individuals to register on the online platform 100 and view the captured content.

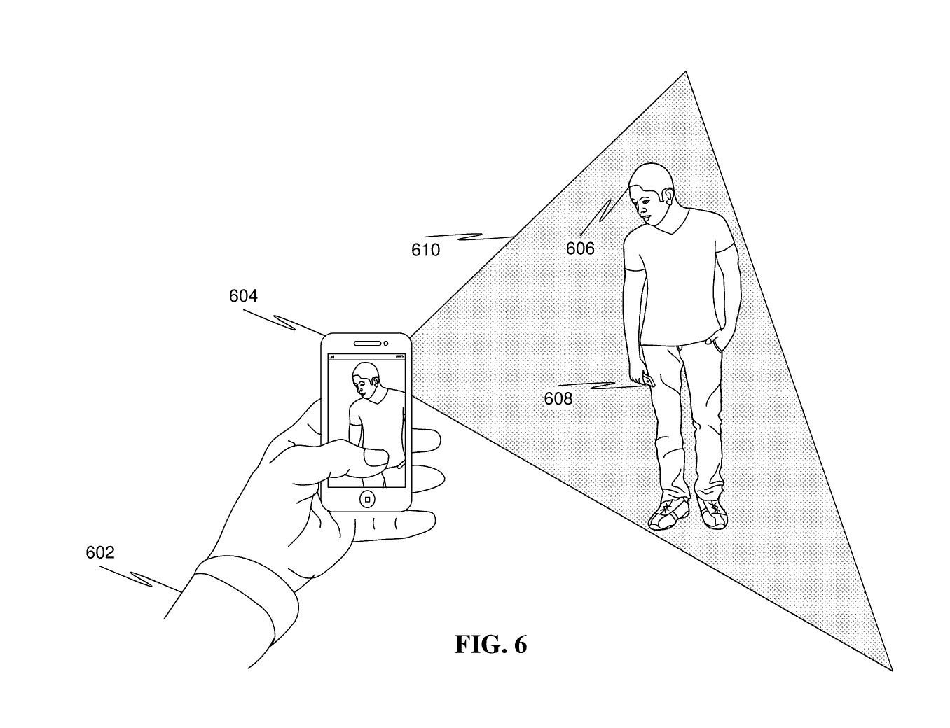

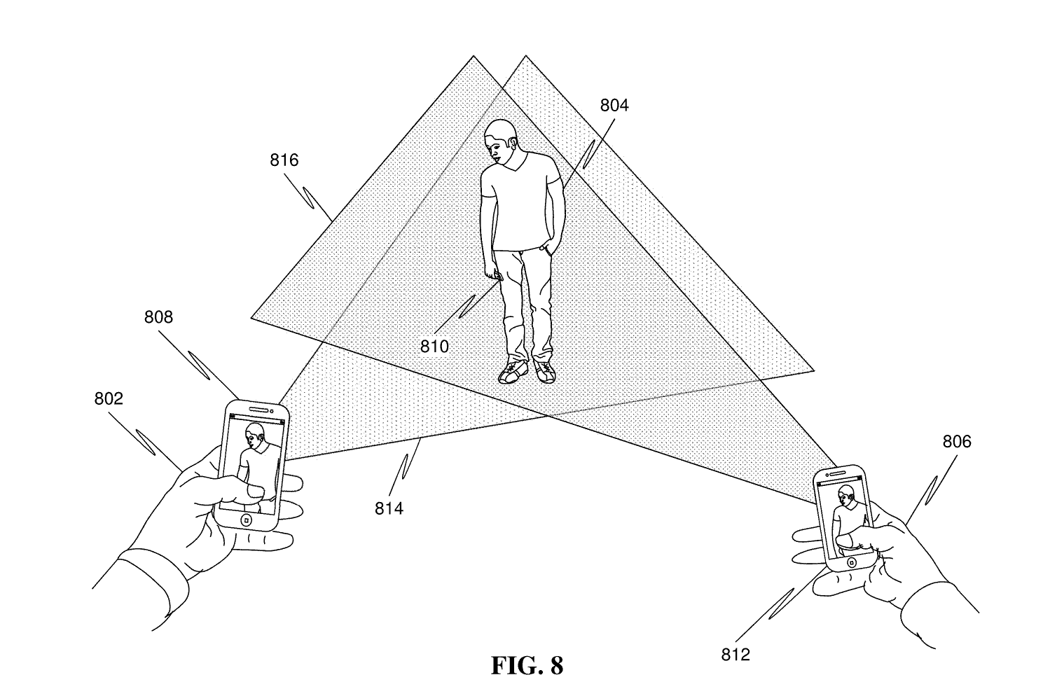

Further, in an embodiment, the content captured by the user may be marked as public and may be shared with all other users registered on the online platform 100 through a personalized feed. The captured content may be shared along with the additional parameters such as the location, direction, and orientation of the user device of the user. Further, the user may also add additional information such as a description of the content that may be saved along with the content. Accordingly, as shown in FIG. 6, the one or more other users registered on the online platform 100 may be able to view the captured content. The one or more users may also be able to filter the captured content by the additional parameters and may view the captured content that may be marked as public. For instance, as shown in FIG. 8, the one or more users may set the current location as a filter and view content that may have been captured nearby.

Further, in an embodiment, even if a user is not determined to be the subject of recorded content through analysis of the location of the user and the analysis of the location, direction, and angle of the camera in the capturing device, a user may be determined to be present in the captured content. For example, image analysis may be performed on the captured content and facial recognition algorithms may be used to create a facial profile of the one or more subjects in the captured content. Accordingly, the created facial profile may be analyzed against data retrieved from the one or more user profiles of the one or more users of the online platform 100, such as the one or more profile pictures, and one or more users may be determined to be subjects in the captured content. In an instance, data to perform facial recognition, such as images may be retrieved from a plurality of external data sources such as, but not limited to, social networking databases. Accordingly, the images and data retrieved from other data sources may be compared with the facial profile created by the facial recognition algorithms and the identity of the one or more other users may be determined.

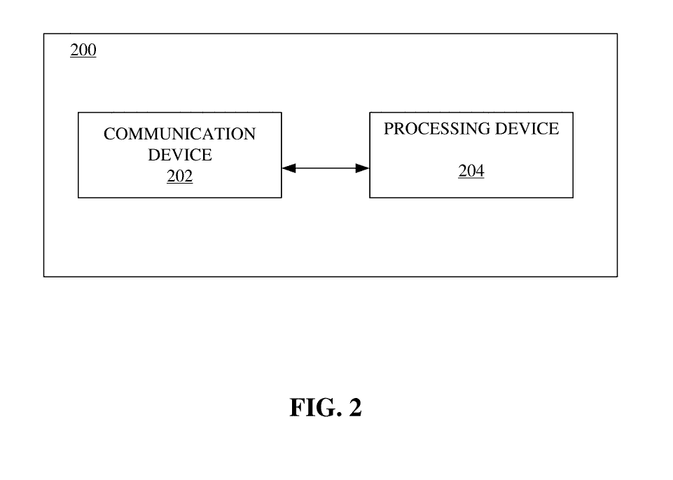

FIG. 2 is a system 200 of facilitating peer-to-peer sharing of at least one image, in accordance with some embodiments. Further, the system 200 may include a communication device 202 configured to receive the at least one image captured by a first user device along with an orientation and a location of the first user device. Further, the first user device may be configured to capture the at least one image through one or more sensors of the first user device, such as a camera, a microphone, and so on. Further, the first user device may be configured to capture the orientation and the location through one or more sensors included in the first user device, such as a location sensor (e.g. GPS), an accelerometer, a gyroscope, and a compass.

Further, the communication device 202 may be configured to receive a location of a second user device. Further, the location of the second user device may be captured through one or more sensors included in the second user device, such as a location sensor (e.g. GPS), an accelerometer, a gyroscope, and a compass. Further, the communication device 202 may be configured to send a notification to the second user device based on matching of a coverage area with the location of the second user device. Further, the notification may be sent to the second user device through one or more notification means, including, but not limited to an application, email, an SMS, a WhatsApp® message, and so on. Further, the notification may be sent to the second user device if the coverage area matches the location of the second user device.

Further, the system 200 may include a processing device 204 configured to determine the coverage area based on a field of view, the orientation and the location of the first user device. Further, the processing device 204 may be configured to match the coverage area with the location of the second user device. Further, a coverage area may include a geographical area in the vicinity of the first user device, located towards the direction of the orientation of the first user device. Further, the coverage area may describe an area which the first user device may be able to capture in the at least one image. For instance, if the first user device includes a camera to capture the least one image including a still photo, the coverage area may include a geographical area in the vicinity of the first user device, located towards the direction of the orientation of the first user device, and falling within the field of view of the camera of the first user device, as shown in FIG. 6, and FIG. 8.

In some embodiments, the at least one image may include one or more of at least one still photo and a video.

In some embodiments, the processing device 204 may be further configured to generate a unique code for the at least one image. In an instance, the unique code generated may include a barcode, a QR code, an Aztec Code, or any other type of a matrix barcode, or an alphanumeric passcode. Further, the unique code may include specific information that may be particular to the at least one image. Further, the unique code may be specific and unique for the captured content. Further, in an instance, the unique code may act as a password to access the at least one image.

In some embodiments, a storage device may be configured to store the at least one image along with the unique code, geo-location of the first user device and a time stamp.

In some embodiments, the communication device 202 may be further configured to receive a search request related to the at least one image from a third party. Further, the search request may include one or more of a geo-location and a time stamp. Further, the time stamp may be obtained using one or more sensors of the first user device that may have captured the at least one image. Further, the time stamp may describe a time of capture of the at least one image. Further, in some embodiments, the search request related to the at least one image may include the unique code of the at least one image, including a barcode, a QR code, an Aztec Code, a matrix barcode, or an alphanumeric passcode.

In some embodiments, the communication device 202 may be further configured to transmit the at least one image to the third party when the at least one image may be marked public.

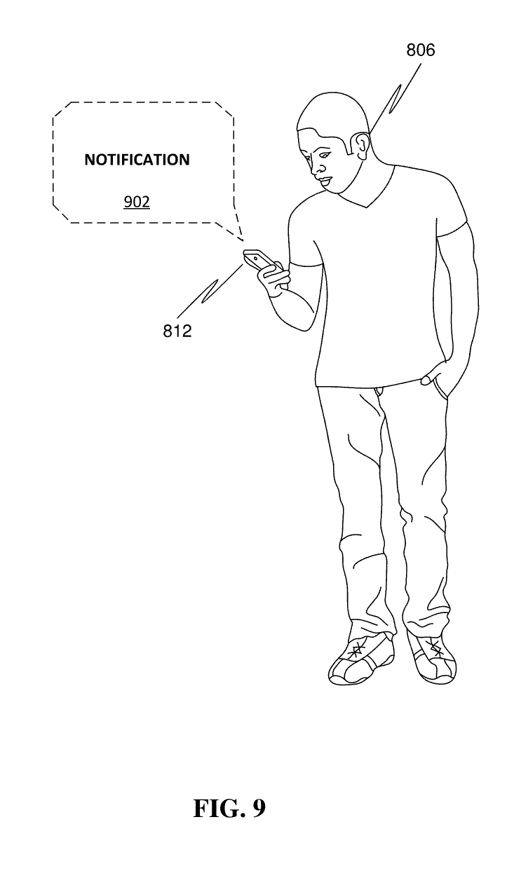

In some embodiments, the processing device 204 may be further configured to perform image analysis on the at least one image. Further, the communication device 202 may be configured to send the notification to the second user device based on the image analysis. For instance, as described in relation with FIG. 8, and FIG. 9, the image analysis may include determining if a face of a second user associated with the second user device may looking towards the first user device, and the face of the second user associated with the second user device may be visible in the at least one image. Further, the communication device 202 may be configured to send the notification to the second user device if the face of the second user associated with the second user device may be visible in the at least one image.

In some embodiments, the communication device 202 may be further configured to send the notification anonymously.

In some embodiments, the communication device 202 may be further configured to send the notification to a plurality of users.

In some embodiments, the communication device 202 may be further configured to receive a request from the second user device. Further, the request may include performing one or more of storing a caption along with the at least one image, sharing the at least one image with another user, making the at least one image public, sending message to the first user device, making a payment to purchase a print of the at least one image and deleting the at least one image.

Further, in some embodiments, the first user device may include a recording device including one or more recording sensors, such as a smartphone, an action camera, a portable audio recorder, and so on. Further, the at least one image captured by the first user device may include a characteristic associated with the second user device, including one or more of an orientation, a position, a speed, an acceleration, and so on of the second user device. For instance, if the first user device includes a first vehicle including a Doppler radar for speed measurement of one or more objects in a coverage area associated with the first vehicle, the first vehicle may measure a speed of the second user device (such as a second vehicle) when the second user device may pass through the coverage area of the first vehicle.

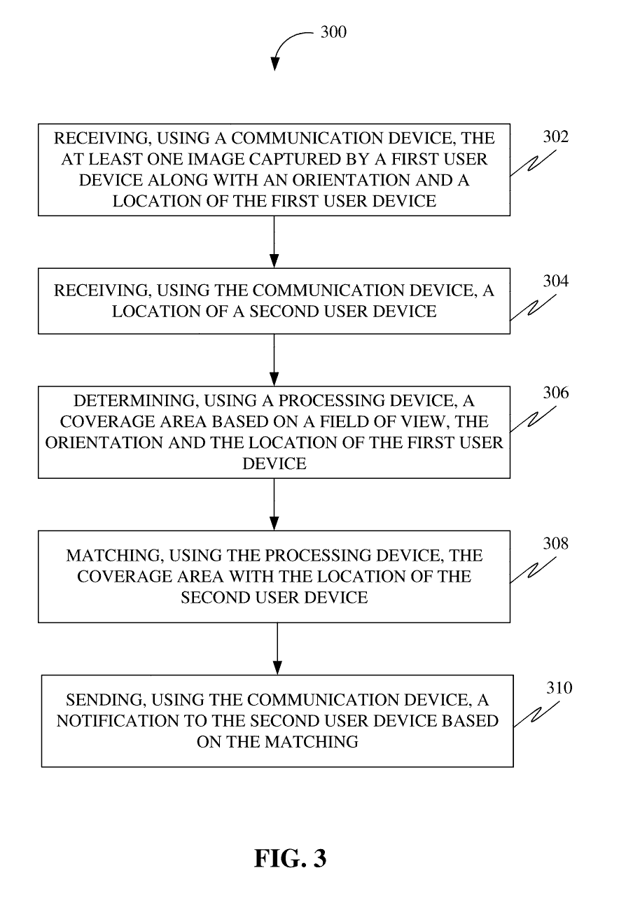

FIG. 3 is a flowchart of a method 300 of facilitating peer-to-peer sharing of at least one image.

At 302, the method 300 may include receiving, using a communication device, such as the communication device 202, the at least one image captured by a first user device along with an orientation and a location of the first user device.

Further, at 304, the method 300 may include receiving, using the communication device, a location of a second user device.

Further, at 306, the method may include determining, using a processing device, such as the processing device 204, a coverage area based on a field of view, the orientation and the location of the first user device.

Further, at 308, the method 300 may include matching, using the processing device, the coverage area with the location of the second user device.

Further, at 310, the method 300 may include sending, using the communication device, a notification to the second user device based on the matching.

In some embodiments, the at least one image may include one or more of at least one still photo and a video.

In some embodiments, the method 300 may further include generating, using the processing device, a unique code for the at least one image.

In some embodiments, the method 300 may further include storing, using a storage device, the at least one image along with the unique code, geo-location of the first user device, and a time stamp.

In some embodiments, the method 300 may further include receiving, using the communication device, a search request related to the at least one image from a third party.

Further, the search request may include one or more of a geo-location and a time stamp.

In some embodiments, the method 300 may further include transmitting, using the communication device, the at least one image to the third party when the at least one image may be marked public.

In some embodiments, the method 300 may further include performing, using the processing device, image analysis on the at least one image. Further, the sending, using the communication device, of the notification to the second user device may be further based on the image analysis.

In some embodiments, the sending the notification may include sending, using the communication device, the notification anonymously.

In some embodiments, the sending of the notification may include sending the notification, using the communication device, to a plurality of users.

In some embodiments, the method 300 may further include receiving, using the communication device, a request from the second user device. Further, the request may include performing one or more of storing a caption along with the at least one image, sharing the at least one image with another user, making the at least one image public, sending message to the first user device, making a payment to purchase a print of the at least one image and deleting the at least one image.

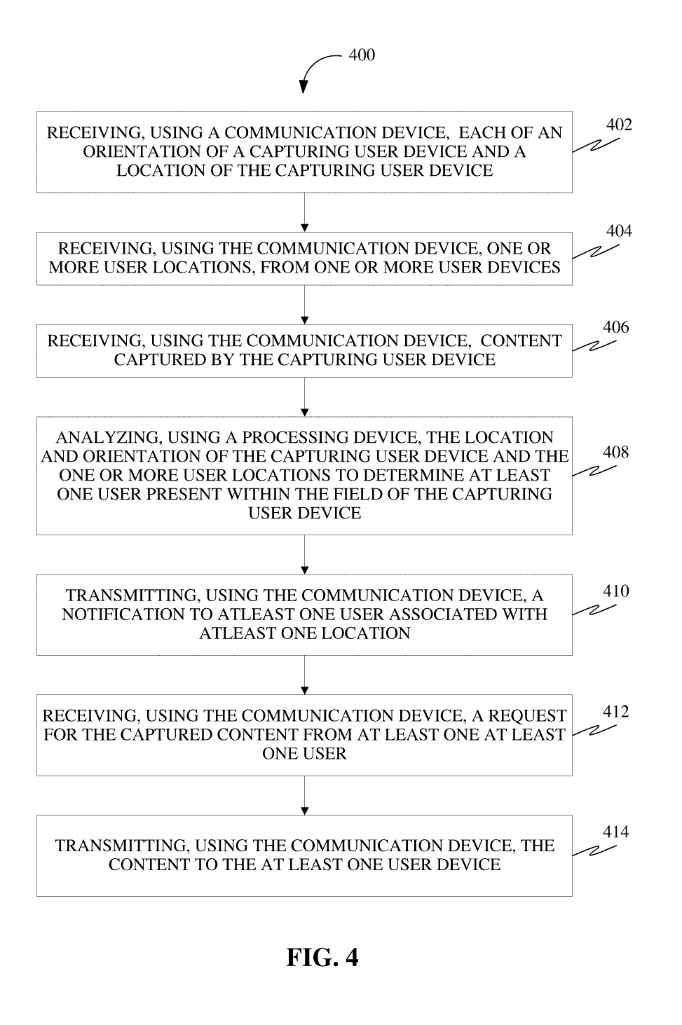

FIG. 4 is a flowchart of a method 400 to facilitate capturing and anonymous sharing of content. Further, at 402, the method 400 may include receiving, using a communication device, each of an orientation, direction, and location from at least one capturing user device. Each of the orientation, direction, and location may be received from one or more sensors in the capturing user device, such as a location sensor (e.g. GPS), an accelerometer, a gyroscope, and a compass. Further, the capturing user device may be configured to communicate with the communication device of a server computer.

Accordingly, in an instance, the one or more identifiers input through the input mechanism may be transmitted from the user device to the server computer. In some embodiments, the orientation, direction, and location may be automatically retrieved from the capturing user device and/or transmitted to the server computer. For example, the capturing user device may be configured to store and transmit the content automatically.

Further, at 404, the method 400 may include receiving, using the communication device, one or more user locations associated with one or more users from one or more user devices associated with the one or more users. The one or more user locations may be received from one or more sensors of the one or more user devices of the one or more users, such as a location sensor (e.g. GPS). In an instance, the one or more user locations associated with one or more users may be automatically retrieved from the one or more user devices and/or transmitted to the server computer. For example, the user device may be configured to store and transmit the one or more user locations associated with one or more users automatically.

Further, at 406, the method 400 may include a receiving, using the communication device, content captured by the capturing user device. The content may include images, videos with audio, videos without audio, and audio. Accordingly, in an instance, the content captured by the capturing user device may be received through an input mechanism of the capturing user device such as a smartphone, a tablet computer, a mobile device, a wearable device, or a smart camera. The user may make use of the camera and/or the microphone of the user device to capture the content. In some embodiments, the content captured by the capturing device may be automatically retrieved from the capturing user device and/or transmitted to the server computer. For example, the capturing user device may be configured to store and transmit the content captured by the capturing device automatically.

Further, at 408, the method 400 may include a step of analyzing, using a processing device, each of the location and orientation of the capturing user device, and the one or more user locations in order to determine at least one user location present within the field of view of the camera. Each of the orientation, direction, and location received from one or more sensors in the capturing user device may be analyzed and compared with the one or more user locations. Accordingly, if a match is found between the orientation, direction, and location received from one or more sensors in the capturing user device and the one or more user locations, one or more of other users may be determined to be subjects in the content captured by the capturing user device.

Further, at 410, the method 400 may include transmitting, using the communication device, a notification to at least one user associated with the at least one user location. The one or more users associated with the one or more user locations may be sent a notification notifying the one or more users that the one or more users may have been captured in the content captured by the capturing user device. The notification may include information detailing the location where the content may have been captured and the direction and distance from which the content may have been captured from. Further, the notification may include the personal user id or username of the user who may have captured the content. Further, in an embodiment, personal information of the user who may have captured the content may not be transmitted.

Further, at 412, the method 400 may include receiving, using the communication device, a request for the captured content from at least one user device associated with the at least one user. The at least one user may request to view and save the captured content files through an input mechanism of the one or more user devices. Alternatively, the one or more users may, through the input mechanism of the one or more user devices, not accept to view or save the captured content. Accordingly, the captured content may be deleted. In an embodiment, the captured content may also be deleted from the capturing user device of the capturing user.

Further, at 414, the method 400 may include a step of transmitting, using the communication device, the captured content to the one or more user devices associated with the one or more users. The captured content that may be featuring the one or more users may be transferred to the respective one or more user devices of the one or more users.

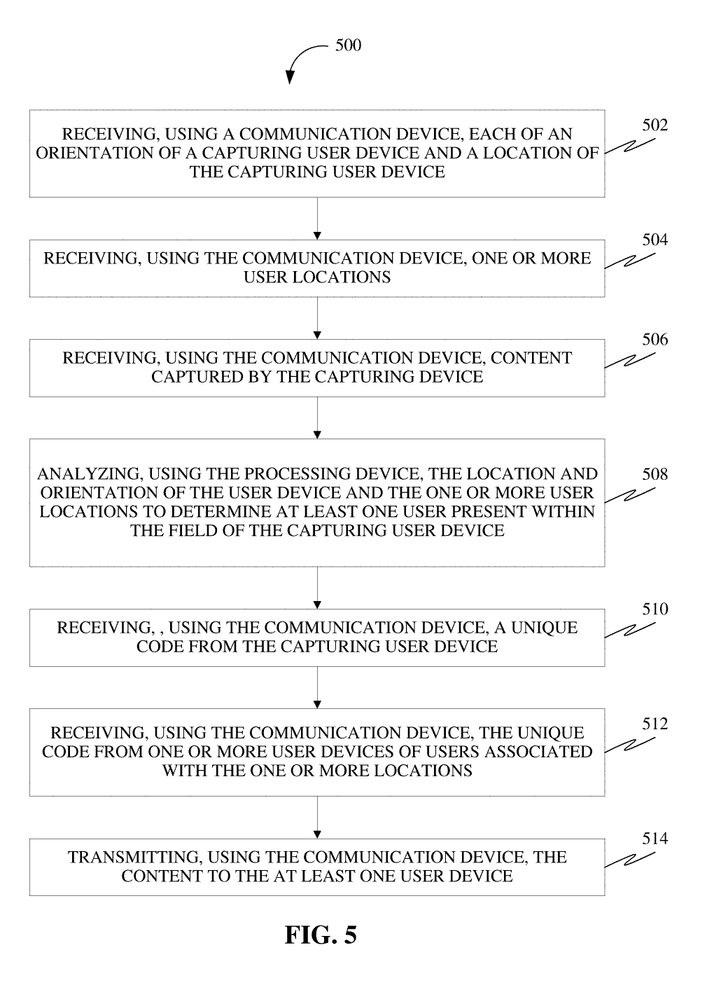

FIG. 5 is a flowchart of a method 500 to facilitate the capturing and anonymous sharing of captured content, including sharing the captured content through a unique code. Further, at 502, the method 500 may include receiving, using a communication device, each of an orientation, direction, and location from at least one capturing user device. Each of the orientation, direction, and location may be received from one or more sensors in the capturing user device, such as a location sensor (e.g. GPS), an accelerometer, a gyroscope, and a compass. Further, the capturing user device may be configured to communicate with the communication device of a server computer. Accordingly, in an instance, the one or more identifiers input through the input mechanism may be transmitted from the user device to the server computer. In some embodiments, the orientation, direction, and location may be automatically retrieved from the capturing user device and/or transmitted to the server computer. For example, the capturing device may be configured to store and transmit the content automatically. Further, at 504, the method 500 may include receiving, using the communication device, one or more user locations associated with one or more users from one or more user devices associated with the one or more users. The one or more user locations may be received from the sensors of the one or more user devices of the one or more users. The sensors may include a location sensor (e.g. GPS). In an instance, the one or more user locations associated with one or more users may be automatically retrieved from the one or more user devices and/or transmitted to the server computer. For example, the user device may be configured to store and transmit the one or more user locations associated with one or more users automatically.

Further, at 506, the method 500 may include, receiving using the communication device, content captured by the capturing user device. The content may include images, videos with audio, videos without audio, and audio. Accordingly, in an instance, the content captured by the capturing user device may be received through an input mechanism of the capturing user device such as a smartphone, a tablet computer, a mobile device, a wearable device, or a smart camera. The user may make use of the camera and/or the microphone of the user device to capture the content. In some embodiments, the content captured by the capturing device may be automatically retrieved from the capturing user device and/or transmitted to the server computer. For example, the capturing user device may be configured to store and transmit the content captured by the capturing device automatically.

Further, at 508, the method 500 may include a step of analyzing, using a processing device, each of the location and orientation of the capturing user device, and the one or more user locations in order to determine at least one user location present within the field of view of the camera. Each of the orientation, direction, and location received from one or more sensors in the capturing user device may be analyzed and compared with the one or more user locations. Accordingly, if a match is found between the orientation, direction, and location received from one or more sensors in the capturing user device and the one or more user locations, one or more of other users may be determined to be subjects in the content captured by the capturing user device.

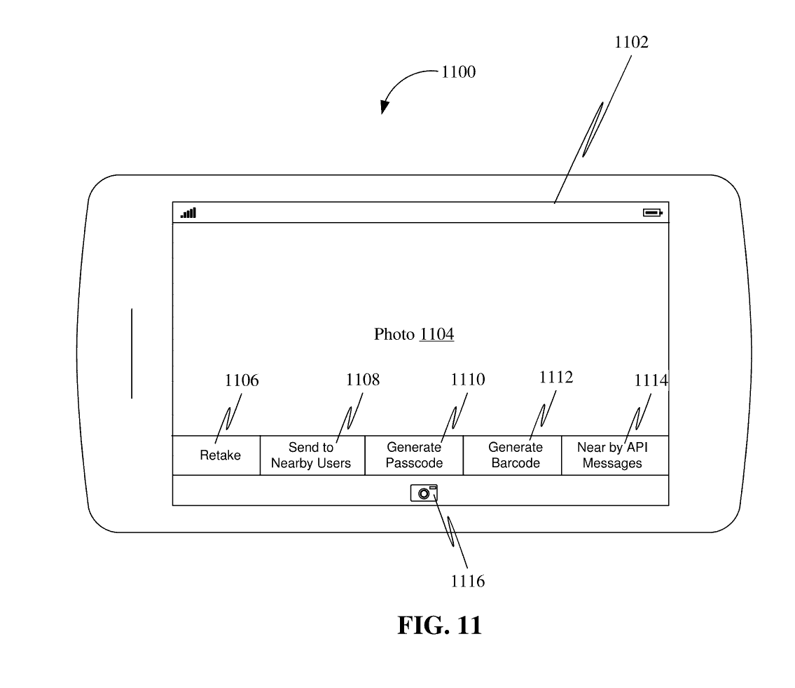

Further, at 510, the method 500 may include receiving, using the communication device, a unique code related to the captured content. In an instance, the unique code generated may include a barcode, a QR code, an Aztec Code, or any other type of a matrix barcode, or even an alphanumeric passcode. In an instance, as shown in FIG. 11, the unique code may be generated by the capturing user device, such as a user through as a user interface and may include specific information that may be particular to the captured content. The generated unique code may be specific and unique for the captured content. Accordingly, the unique code may be used as a password to access the captured content.

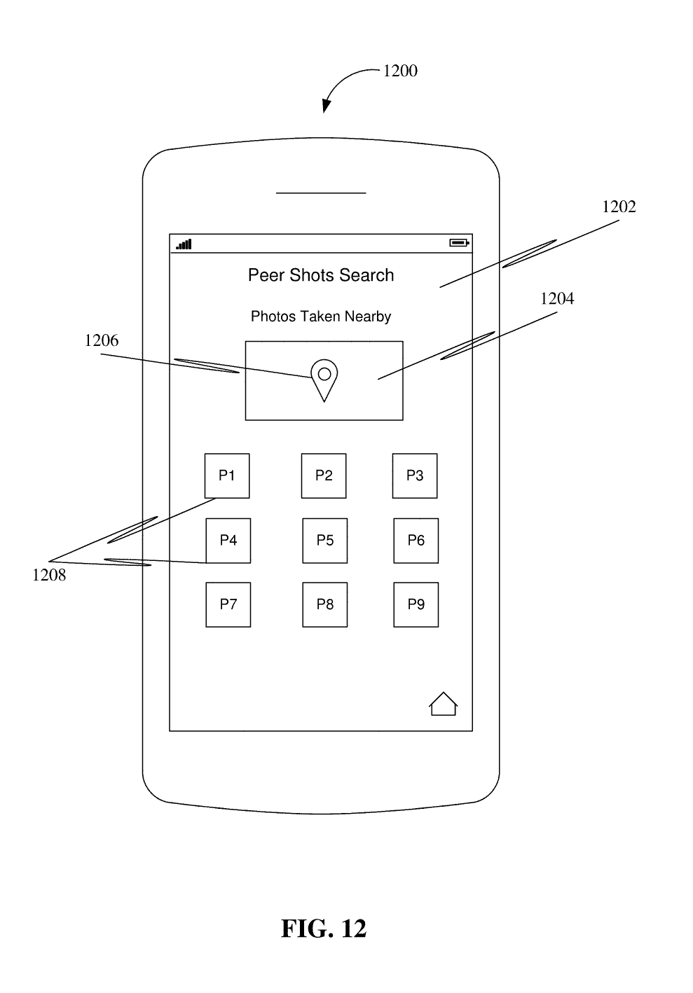

Further, at 512, the method 500 may include receiving, using the communication device, the unique code from one or more user devices of users associated with the one or more locations. The unique code received may be particular to a specific content and may be received as a request to access the captured content. In an instance, as shown in FIG. 12, the one or more users may input the unique code through an input mechanism of the one or more user devices and transmit the unique code to view and save the captured content through an input mechanism of the one or more user devices.

Further, at 514, the method 500 may include transmitting, using the communication device, the captured content to the one or more user devices associated with the one or more users. The captured content that may be featuring the one or more users may be transferred to the respective one or more user devices of the one or more users.

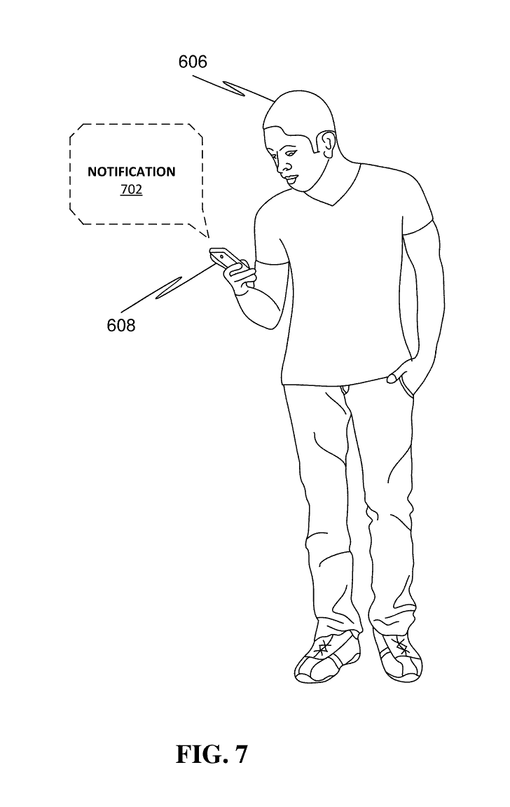

FIG. 6 is an exemplary embodiment of a system to facilitate peer-to-peer sharing of at least one image, where a first user 602 may capture content including a second user 606, in accordance with some embodiments. Further, a first user device 604 associated with the first user 602 may be configured to capture content such as audio, video, or images. Further, the first user 602 may wish to capture an image of the second user 606 using the first user device 604. Accordingly, each of an orientation, direction, and location of the first user device 604 may be received through a communication device from the first user device 604. Each of the orientation, direction, and location may be received from one or more sensors in the capturing user device, such as a location sensor (e.g. GPS), an accelerometer, a gyroscope, and a compass. Further, the specifications of the first user device 604, including the specifications of the sensors of the user device such as the camera of first user device 604 including the light sensor, the focal length of the lens, aperture of the lens, field of view etc. may also be received. Further, the user location associated with the second user 606 may be received from a second user device 608 associated with the second user 606. The user location may be received from the sensors of the second user device 608. The sensors may include a location sensor (e.g. GPS). In an instance, the user location associated with the second user 606 may be automatically retrieved from the user devices 2 and/or transmitted to the server computer. For example, the second user device 608 may be configured to store and transmit the user location associated with the second user 606 automatically. Further, using a processing device, each of the location and orientation of the first user device 604, and the user locations received from the second user device 608 may be analyzed to determine that the second user 606 may be present within a coverage area 610 of the camera of the first user device 604. Further, the first user 602 may capture an image of the second user 606 through the first user device 604. Accordingly, as shown in FIG. 7, a notification may be transmitted using the communication device to the second user device 608 of the second user 606. The second user 606 may be sent a notification notifying that the second user 606 may have been captured in the content captured by the first user 602 through the first user device 604. The notification 702 may include information detailing the location, where the content may have been captured and the direction and distance from which the content may have been captured from. Further, the notification 702 may include a personal user id or username of the first user 602. Further, in an embodiment, personal information of the first user 602 may not be shared. Accordingly, the second user 606 may transmit a request to view the content captured by the second user device 608. Alternatively, the second user 606 may not accept to view or save the captured content and the captured content may be deleted. In an embodiment, the captured content may also be deleted from the first user device 604 of the first user 602. Further, the captured content may be transmitted to the second user device 608.

FIG. 8 is an exemplary embodiment of a system to facilitate peer-to-peer sharing of at least one image, where a first user 802, and a third user 806 may capture content including a second user 804, in accordance with some embodiments. Further, the first user 802, and the third user 806 may capture content such as audio, video, or images using a first user device 808 associated with the first user 802, and a third user device 812 associated with the third user 806. Further, the second user 804 may be located near the first user 802 and third user 806, holding a second user device 810.

The first user 802, and the third user 806 may wish to capture an image of the second user 804 using the first user device 808, and the third user device 812 respectively. Accordingly, each of an orientation, direction, and location of the first user device 808, and the third user device 812 may be received. Each of the orientation, direction, and location may be received from one or more sensors in the first user device 808, and the third user device 812, such as a location sensor (e.g. GPS), an accelerometer, a gyroscope, and a compass. Further, the specifications of the first user device 808, and the third user device 812, including the specifications of the sensors of the user device such as the camera of user devices 1 and 3 including the light sensor, the focal length of the lens, aperture of the lens etc. may also be received. Further, the user location associated with the second user 804 may be received from the second user device 810. The user location may be received from the sensors of the second user device 810. Further, using a processing device, each of the location and orientation of the first user device 808, and the third user device 812, and the user location received from the second user device 810 may be analyzed to determine that the second user 804 may be present within a first covering area 814, and a second covering area 816 of the first user device 808, and the third user device 812 respectively. Further, the first user 802, and the third user 806 may capture an image of the second user 804 through the first user device 808, and the third user device 812. However, the images captured by the first user 802, and the third user 806 may be different due to differences in the location, positioning, and angle of the first user device 808, and the third user device 812. Accordingly, the images may be analyzed to determine the differences between the captured images. For instance, image analysis may be performed on the images captured by the first user 802, and the third user 806 and facial recognition algorithms may be used to create a facial profile of the second user 804. In an instance, the first user 802 may be able to capture an image of the second user 804 from the front and the face of the second user 804 may be visible in the captured image. The third user 806 may only be able to capture a silhouette of the second user 804. Accordingly, as shown in FIG. 9, a notification 902 may be transmitted to the second user device 810 of the second user 804 notifying that the second user 804 may have been captured in the content captured by the first user 802, and the third user 806. The notification 902 may include information detailing the location, where the content may have been captured and the direction and distance from which the content may have been captured from. However, in an embodiment, the second user 804 may, through an input mechanism of the second user device 810, customize the conditions in which the second user 804 may receive the notification 902. For instance, the second user 804 may alter the settings of a personal user profile to receive notifications for only images captured that may include a front profile and a face of the second user 804. Accordingly, the second user 804 may only receive a notification that the first user 802, at a particular location and from a specific direction, may have captured the second user 804 in an image. Further, the notification may include a personal user id or username of the first user 802. However, the personal information of the first user 802 may not be shared. Accordingly, the second user 804 may transmit a request to view the content captured through the second user device 810. Alternatively, the second user 804 may not accept to view or save the captured content and the captured content may be deleted. In an embodiment, the captured content may also be deleted from the first user device 808 of the first user 802. Further, the captured content may be transmitted to the second user device 810.

FIG. 10 is a user device 1000 with a user interface 1002 of a smartphone application, in accordance with some embodiments. Accordingly, the user interface 1002, in an instance, may allow a user to view a one or more of captured content (such as photos/videos 1004) that may be captured by one or more other users registered on the online platform 100. Further, the user, in an instance, may be able to filter the captured content by additional parameters (such as, but not limited to, location search 1006, content search 1008) and/or may view comments (such as a comment 1012) by the one or more other users. Further, the user interface 1002, in an instance, may allow the user to capture a content by tapping and/or clicking on a camera button 1010.

FIG. 11 is a user device 1100 with a user interface 1102 of a smartphone application, in accordance with some embodiments. Accordingly, the user interface 1102, in an instance, may allow a user to perform one or more actions on a content (such as a photo 1104) captured by the user. For instance, the one or more actions may include activities such as (but not limited to) retaking the content (such as by taping on Retake 1106), sharing with other nearby users (such as by taping on Send to Nearby users 1108), generating a unique code for the photo 1104 (such as by taping on generate passcode 1110), generating a barcode for the photo 1104 (such as by taping on Generate Barcode 1112), and/or accessing Nearby API messages (such as by taping on Nearby API messages 1114) etc. Further, the user interface 1102, in an instance, may allow the user to capture the content by tapping and/or clicking on a camera button 1116.

FIG. 12 is a user device 1200 with a user interface 1202 of a smartphone application, in accordance with some embodiments. Accordingly, the user interface 1202, in an instance, may allow a user to set a location on a map 1204 (such as by dropping a pin 1206 on the map 1204) as a filter and view content (such as a plurality of pictures 1208) that may have been captured by one or more other users nearby.

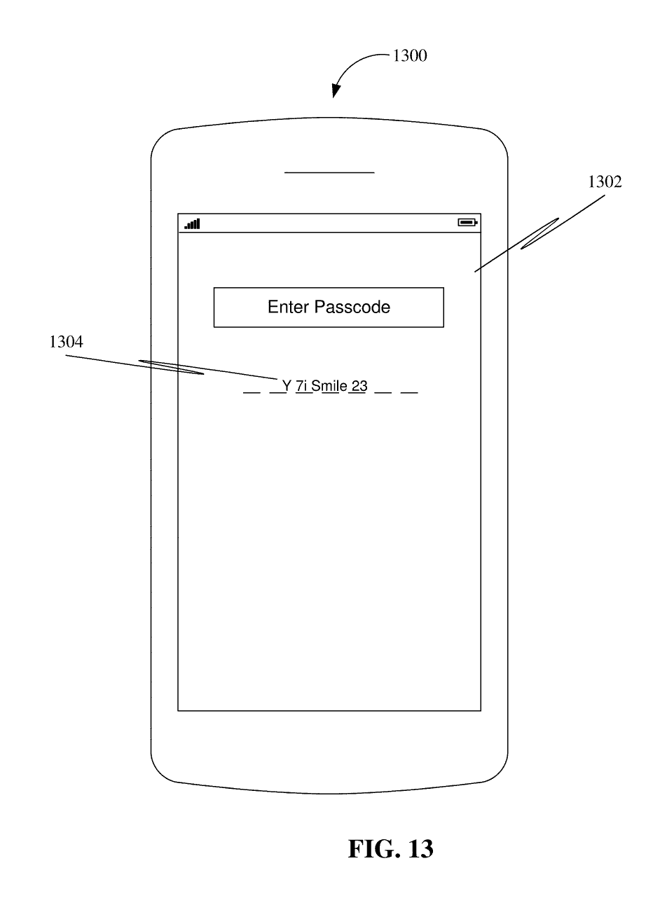

FIG. 13 is a user device 1300 with a user interface 1302 of a smartphone application, in accordance with some embodiments. Accordingly, the user interface 1302, in an instance, may allow a user to enter a passcode (such as an alphanumeric code 1304) in order to access a database (such as databases 108) hosted on the online platform 100 and view a captured content.

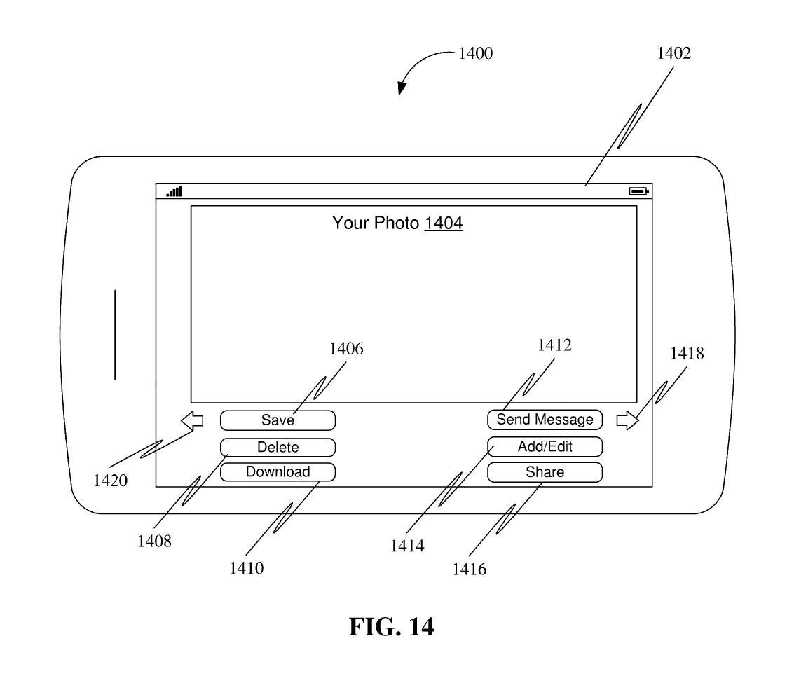

FIG. 14 is a user device 1400 with a user interface 1402 of a smartphone application, in accordance with some embodiments. Accordingly, the user interface 1402, in an instance, may allow a user to view content (such as a photo 1404) that may include one or more characteristics (such as, but not limited to, face) of the user. Further, the user interface 1402, in an instance, may allow a user to perform one or more actions on the content (such as the photo 1404). For instance, the one or more actions may include activities such as (but not limited to) saving the content (such as by taping on save 1406), deleting the content (such as by taping on delete 1408), downloading the content (such as by taping on download 1410), sending message (such as by taping on send message 1412), editing the content (such as by taping Add/edit 1414), and/or sharing the content (such as by sharing 1416) etc. Further, the user interface 1402, in an instance, may allow the user to view previous and/or next content by tapping and/or clicking on arrow buttons (such as a right arrow 1418 and/or a left arrow 1420).

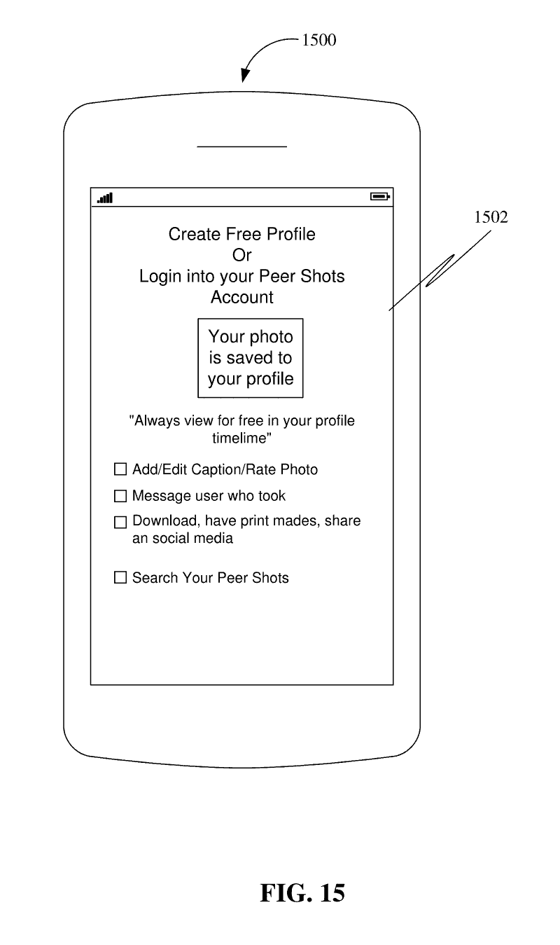

FIG. 15 is a user device 1500 with a user interface 1502 of a smartphone application, in accordance with some embodiments. Accordingly, the user interface 1502, in an instance, may allow a user to create a user profile in order to register the user on the online platform 100.

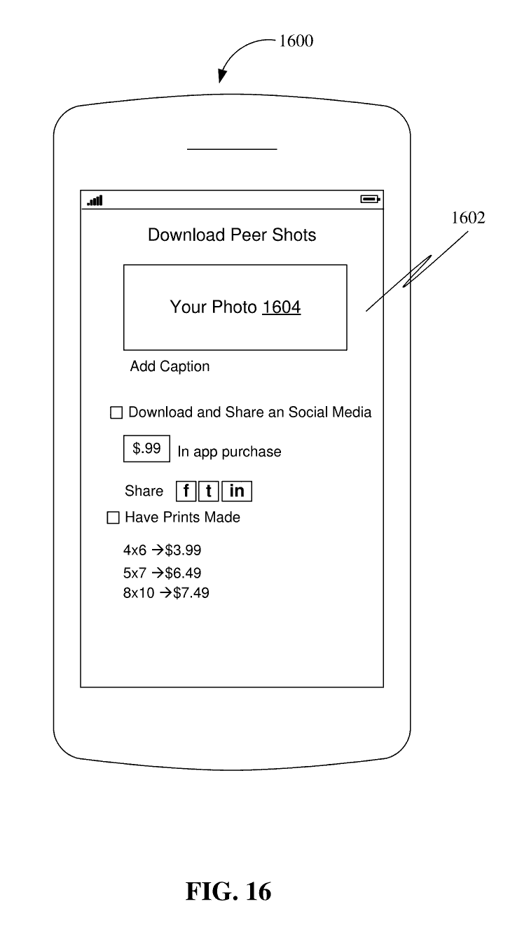

FIG. 16 is a user device 1600 with a user interface 1602 of a smartphone application, in accordance with some embodiments. Accordingly, the user interface 1602, in an instance, may allow a user to download content (such as a photo 1604) that may be captured by one or more other users.

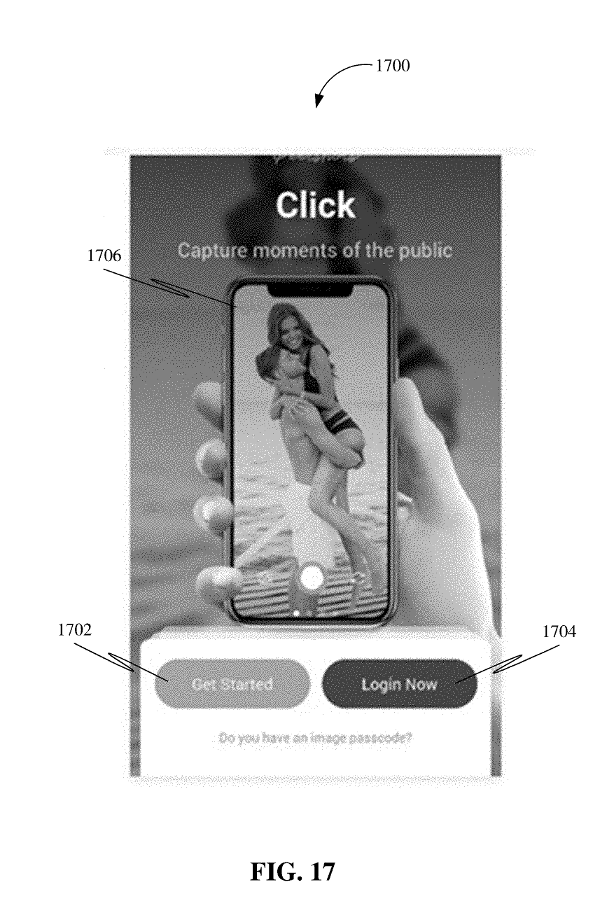

FIG. 17 is a snapshot of a user interface 1700 of a smartphone application, in accordance with an exemplary embodiment. Accordingly, the user interface 1700, in an instance, may provide a feature page which may be visible to a user that may be using the smartphone application. Further, the feature page, in an instance, may include a visual representation (such as a picture 1706) of one or more features (such as a click feature to capture moments of the public). Further, the feature page, in an instance, may allow the user to log-in into the smartphone application through login now 1704. Further, the feature page, in an instance, may allow the user to get started with the smartphone application through an option (such as Get started 1702).

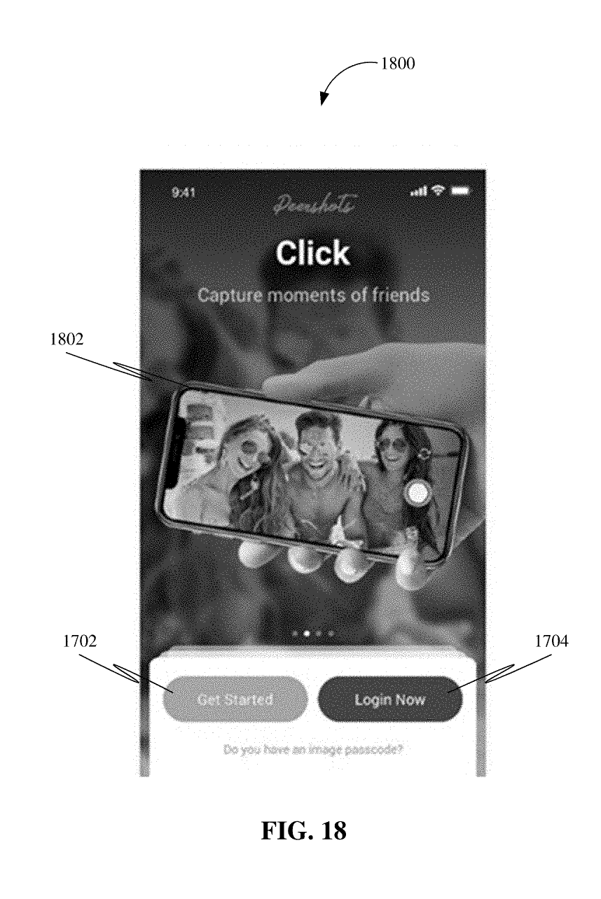

FIG. 18 is a snapshot of a user interface 1800 of a smartphone application, in accordance with an exemplary embodiment. Accordingly, the user interface 1800, in an instance, may provide a feature page which may be visible to a user that may be using the smartphone application. Further, the feature page, in an instance, may include a visual representation (such as a picture 1802) of one or more features (such as a click feature to capture moments of friends). Further, the feature page, in an instance, may allow the user to log-in into the smartphone application through login now 1704. Further, the feature page, in an instance, may allow the user to get started with the smartphone application through an option (such as Get started 1702).

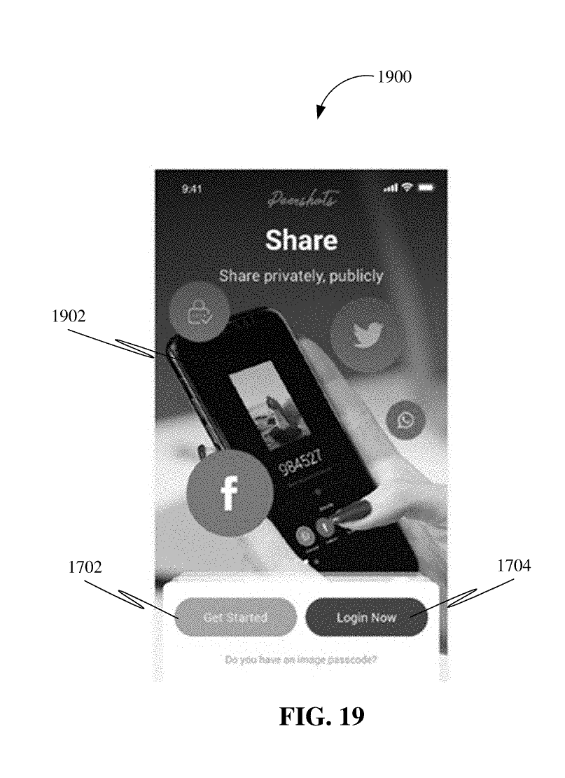

FIG. 19 is a snapshot of a user interface 1900 of a smartphone application, in accordance with an exemplary embodiment. Accordingly, the user interface 1900, in an instance, may provide a feature page which may be visible to a user that may be using the smartphone application. Further, the feature page, in an instance, may include a visual representation (such as a picture 1902) of one or more features (such as a share feature to share a captured content privately and/or publically). Further, the feature page, in an instance, may allow the user to log-in into the smartphone application through login now 1704. Further, the feature page, in an instance, may allow the user to get started with the smartphone application through an option (such as Get started 1702).

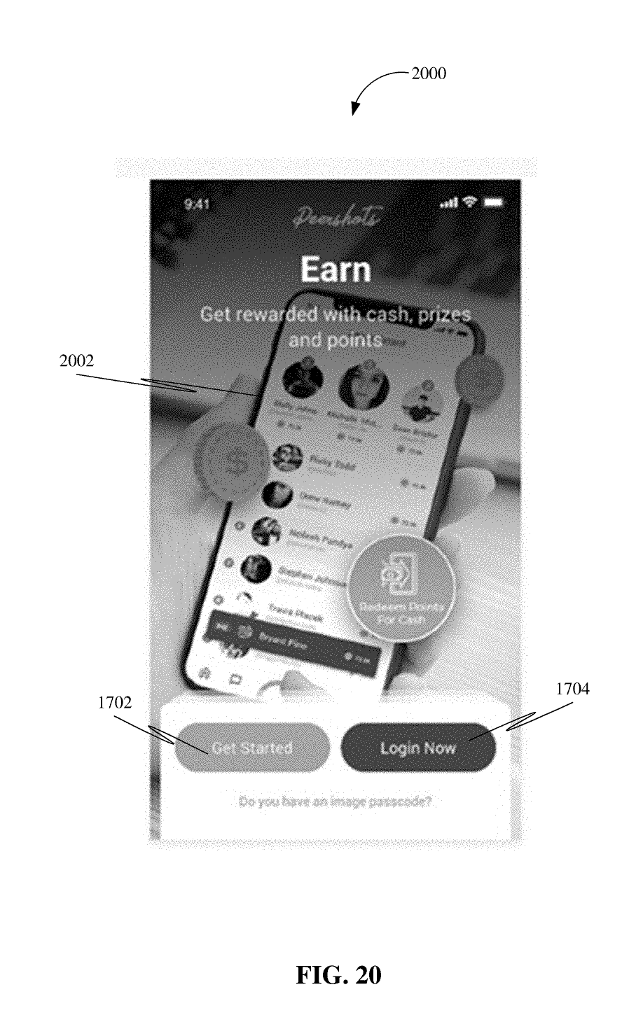

FIG. 20 is a snapshot of a user interface 2000 of a smartphone application, in accordance with an exemplary embodiment. Accordingly, the user interface 2000, in an instance, may provide a feature page which may be visible to a user that may be using the smartphone application. Further, the feature page, in an instance, may include a visual representation (such as a picture 2002) of one or more features (such as an Earn feature that may allow the user to get rewarded with cash, prizes and/or points). Further, the feature page, in an instance, may allow the user to log-in into the smartphone application through login now 1704. Further, the feature page, in an instance, may allow the user to get started with the smartphone application through an option (such as Get started 1702).

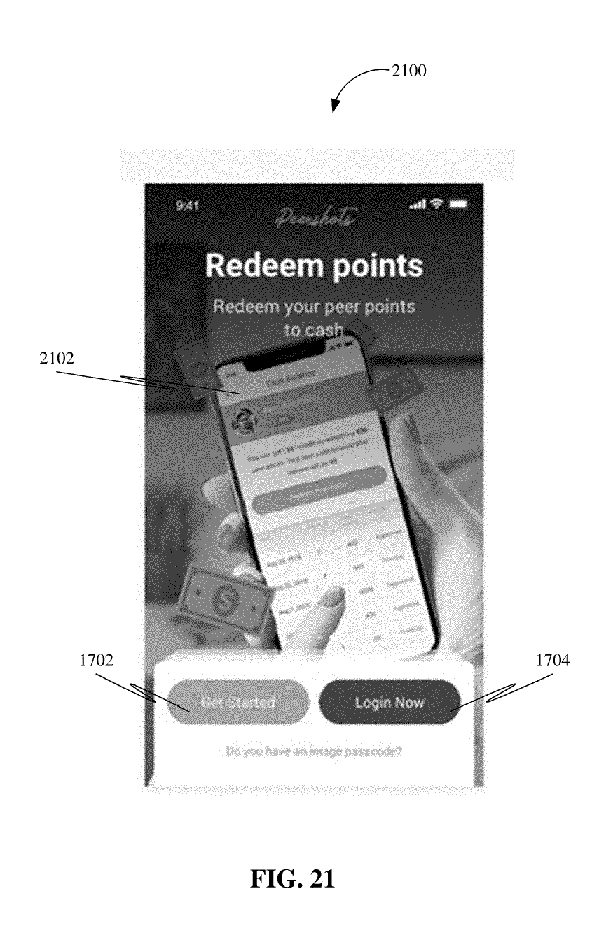

FIG. 21 is a snapshot of a user interface 2100 of a smartphone application, in accordance with an exemplary embodiment. Accordingly, the user interface 2100, in an instance, may provide a feature page which may be visible to a user that may be using the smartphone application. Further, the feature page, in an instance, may include a visual representation (such as a picture 2102) of one or more features (such as a Redeem points feature that may allow the user to redeem peer points to real money). Further, the feature page, in an instance, may allow the user to log-in into the smartphone application through login now 1704. Further, the feature page, in an instance, may allow the user to get started with the smartphone application through an option (such as Get started 1702).

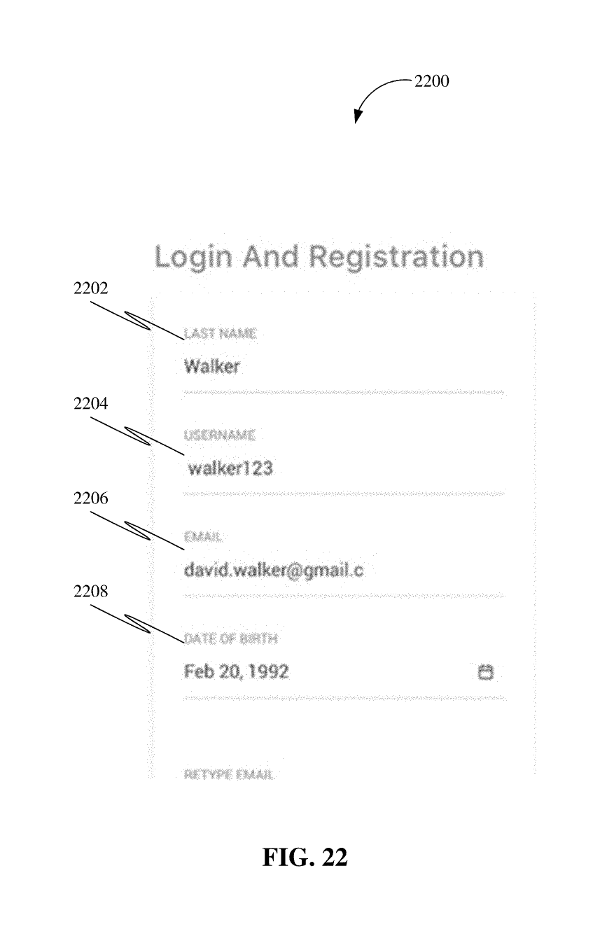

FIG. 22 is a snapshot of a user interface 2200 of a smartphone application, in accordance with an exemplary embodiment. Accordingly, the user interface 2200, in an instance, may be displayed to a user when the user may wish to register with the online platform 100. Further, the user interface 2200, in an instance, may allow the user to input information associated with the user. For instance, the information associated with the user may include (but not limited to) last name 2202, username 2204, email 2206, date of birth 2208 etc.

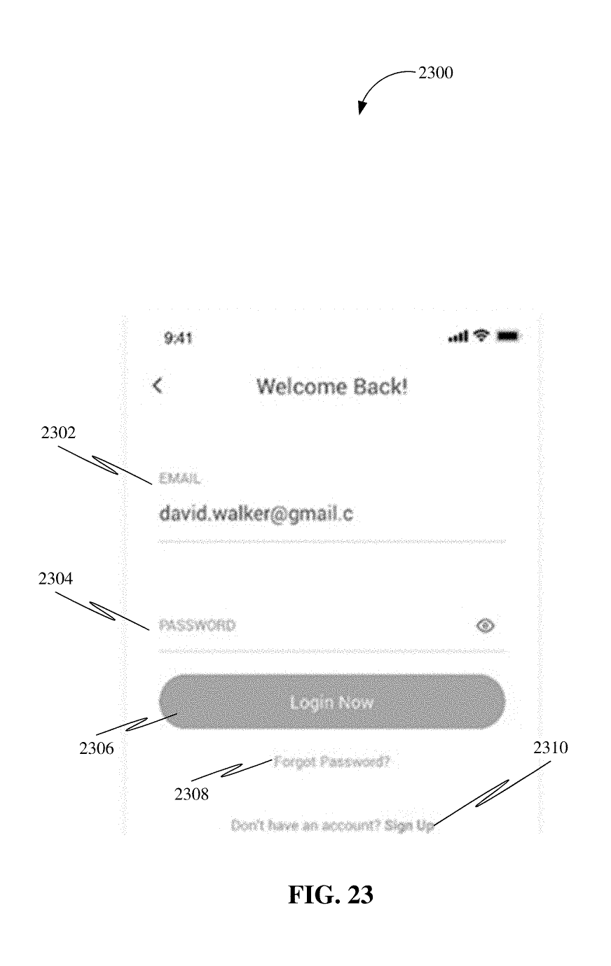

FIG. 23 is a snapshot of a user interface 2300 of a smartphone application, in accordance with an exemplary embodiment. Accordingly, the user interface 2300, in an instance, may be displayed to a user when the user may wish to login into the smartphone application. Further, the user interface 2300, in an instance, may allow the user to input credentials associated with the user. For instance, the credentials associated with the user may include (but not limited to) Email 2302, and/or Password 2304 etc. Further, the user, in an instance, may click and/or tap on Login now 2306 in order to login into the smartphone application. Further, the user, in an instance, may click and/or tap on Forget Password 2308 in case the user forgets credentials associated with the user. Further, the user, in an instance, may click and/or tap on Sign Up 2310 in order to register with the online platform 100.

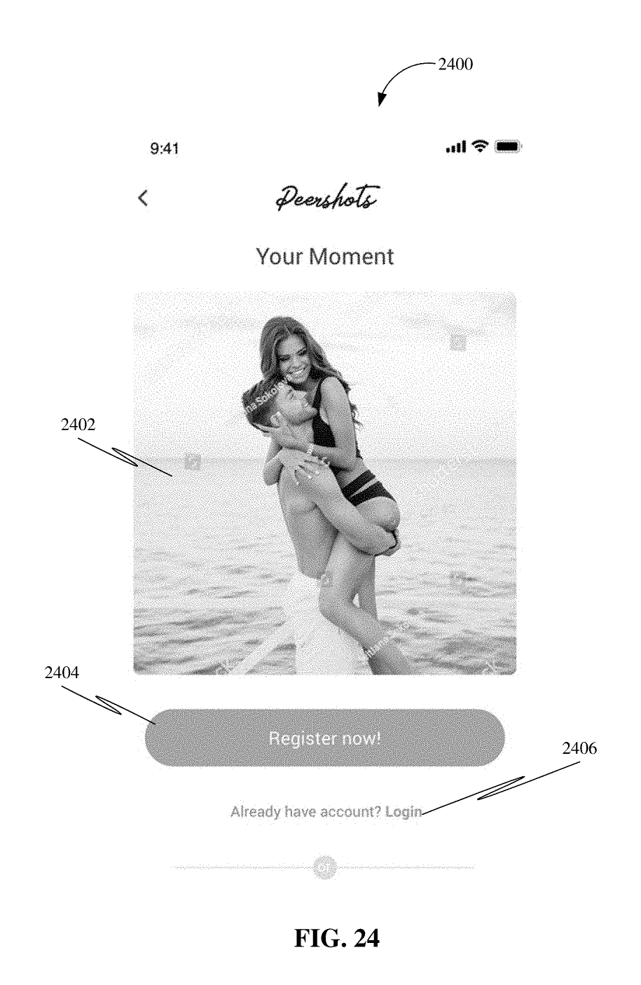

FIG. 24 is a snapshot of a user interface 2400 of a smartphone application, in accordance with an exemplary embodiment. Accordingly, the user interface 2400, in an instance, may be displayed to a user when the user may click a picture 2402 through a content capturing device and the user may not be logged in with the smartphone application yet. Further, the user interface 2400, in an instance, may allow the user to register with the online platform 100 by clicking and/or tapping on Register Now 2404 in a case if a user profile associated with the user may not be stored in a database (such as databases 108) associated with the online platform 100. Further, the user, in an instance, may tap and/or click on Login 2406 in a case if the user may have already registered with the online platform 100.

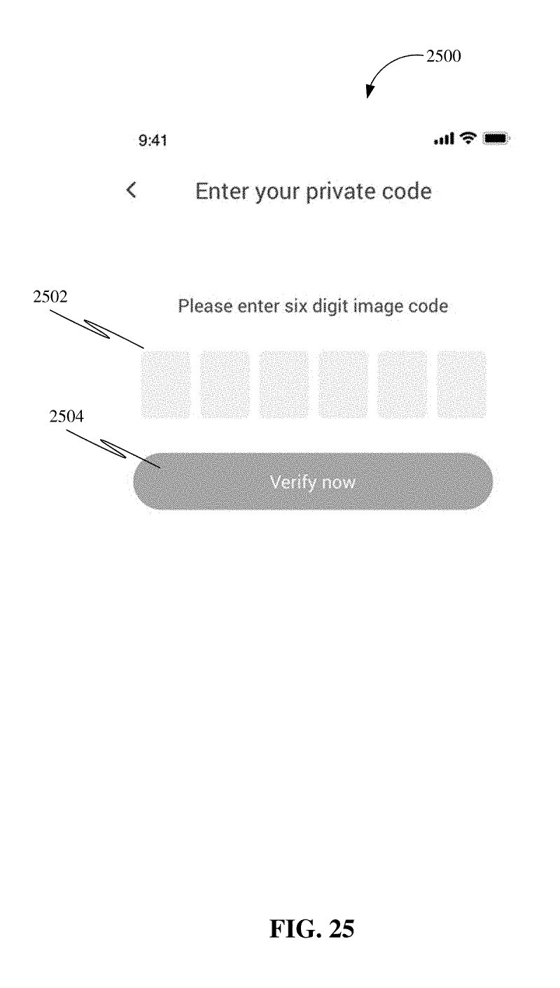

FIG. 25 is a snapshot of a user interface 2500 of a smartphone application, in accordance with an exemplary embodiment. Accordingly, the user interface 2500, in an instance, may allow a user to provide a unique code (such as a six-digit image code) through a code input space 2502 in order to access a database (such as databases 108) hosted on the online platform 100 and view a captured content. Further, the user may share the unique code for the captured content with one or more other users of the online platform 100. Further, the user, in an instance, may verify the unique code by taping and/or clicking on Verify now 2504.

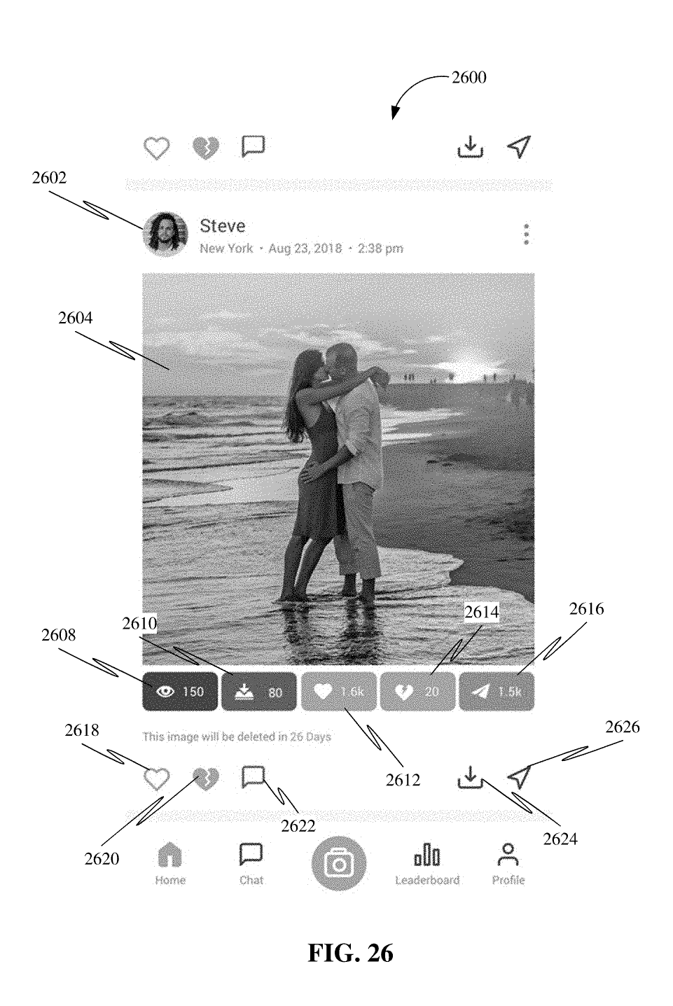

FIG. 26 is a snapshot of a user interface 2600 of a smartphone application, in accordance with an exemplary embodiment. Accordingly, the user interface 2600, in an instance, may display a content (such as a picture 2604) that may be uploaded on the smartphone application by a user with a user profile 2602. Further, the user interface 2600, in an instance, may allow the user to view reactions of other users. For instance, the reactions of other users may include (but not limited to) number of views 2608, number of downloads 2610, number of likes 2612, number of dislikes 2614, number of shares 2616 etc. Further, the user interface 2600, in an instance, may allow the user to provide feedback for the content (such as the picture 2604). For instance, the user may provide feedback such as (but not limited to) like 2618, dislike 2620, comment 2622, download 2624, share 2626 etc.

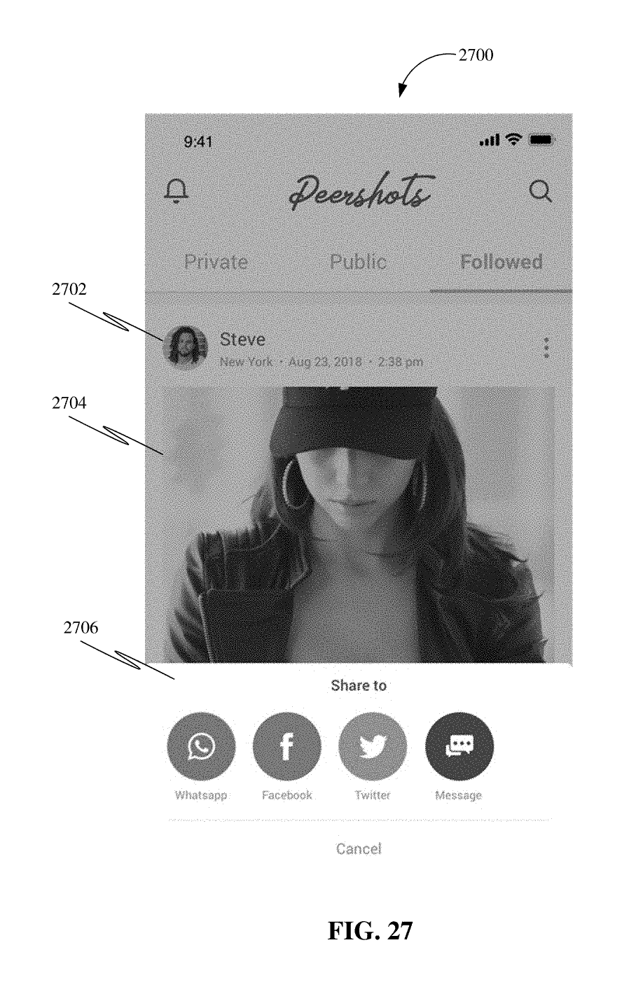

FIG. 27 is a snapshot of a user interface 2700 of a smartphone application, in accordance with an exemplary embodiment. Accordingly, the user interface 2700, in an instance, may be displayed to a user when the user may wish to share content (such as a picture 2704) uploaded by another user profile 2702. Further, the user interface 2700, in an instance, may include a share menu 2706. Further, the share menu 2706, in an instance, may include a list of one or more sharing platforms such as (but not limited to) WhatsApp®, Facebook®, Twitter®, Message etc.

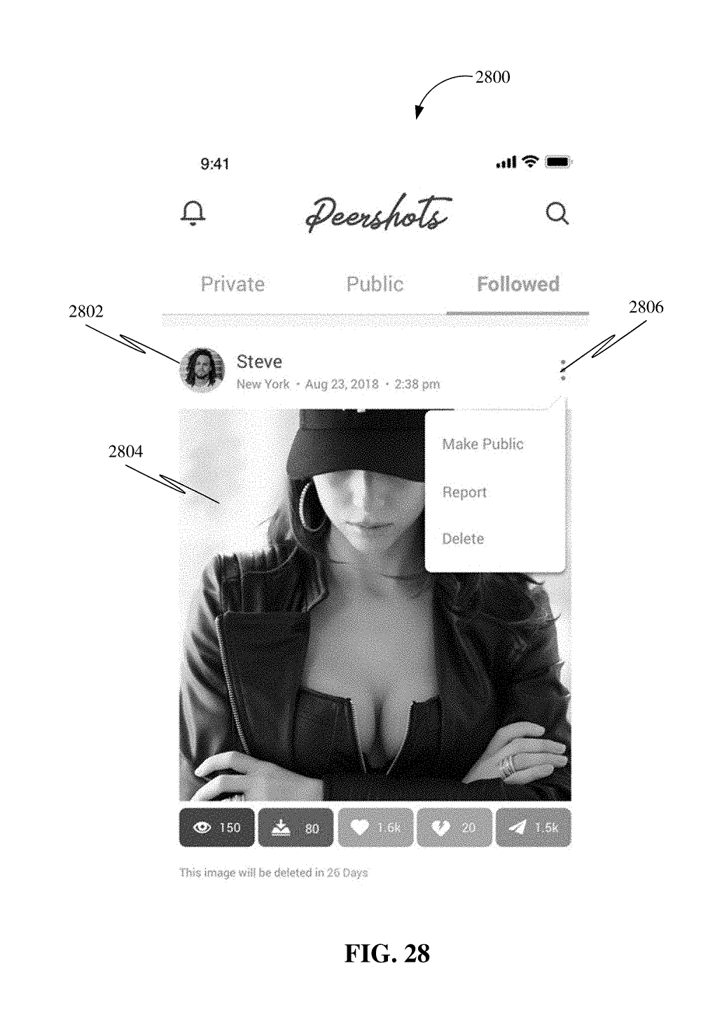

FIG. 28 is a snapshot of a user interface 2800 of a smartphone application, in accordance with an exemplary embodiment. Accordingly, the user interface 2800, in an instance, may allow a user to take action on a content (such as a picture 2804) uploaded by another user 2802. Further, the user, in an instance, may take action on the content by taping and/or clicking on an option menu 2806. Further, the option menu 2806, in an instance, may include options such as (but not limited to) Make public (in order to make the content public), Report (in order to report the online platform 100 about the content), and/or delete (in order to delete the content from the database 108 associated with the online platform 100) etc.

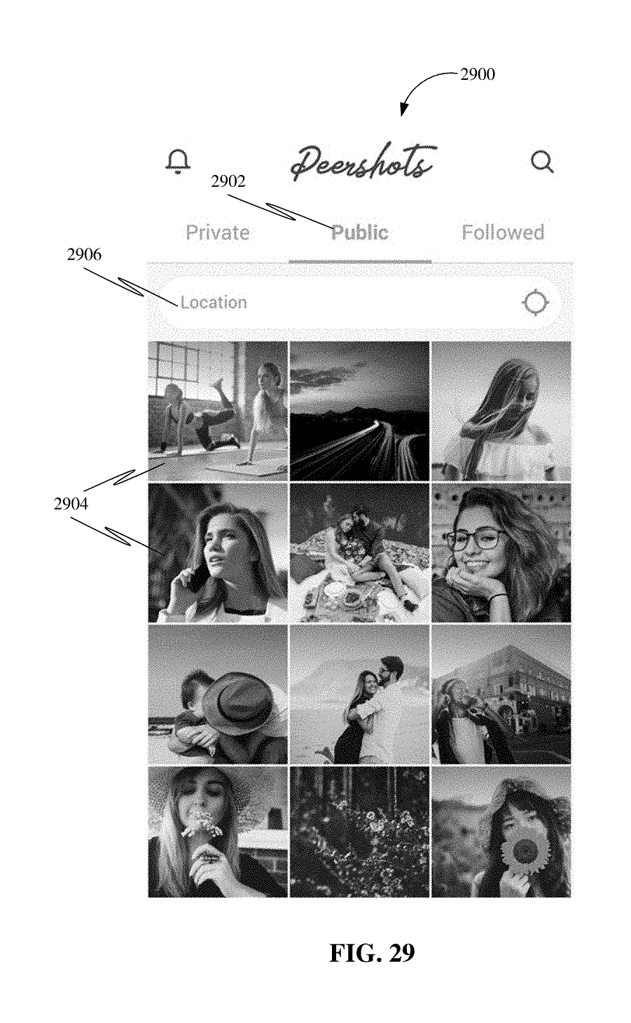

FIG. 29 is a snapshot of a user interface 2900 of a smartphone application, in accordance with an exemplary embodiment. Accordingly, the user interface 2900, in an instance, may allow the user to view one or more content (such as a plurality of photographs 2904) captured by one or more users. For instance, the user may tap on Public 2902 in the user interface 2900 in order to view the one or more content in an array. Further, the user may search the one or more content by taping on Location 2906 in the user interface 2900.

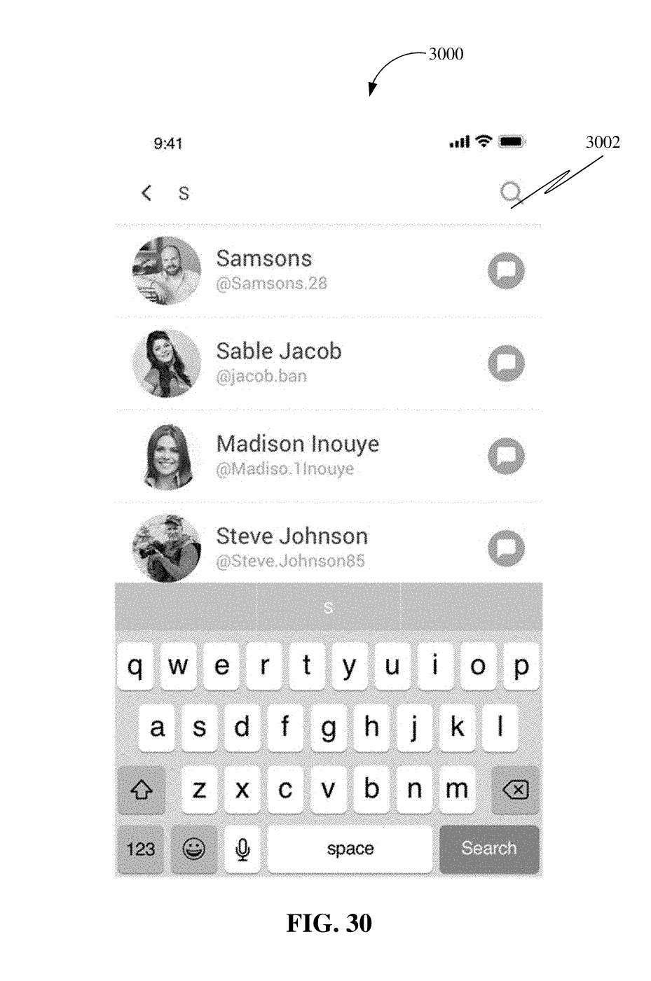

FIG. 30 is a snapshot of a user interface 3000 of a smartphone application, in accordance with an exemplary embodiment. Accordingly, the user interface 3000, in an instance, may allow a user to search for other users registered with the online platform 100 using a search box 3002.

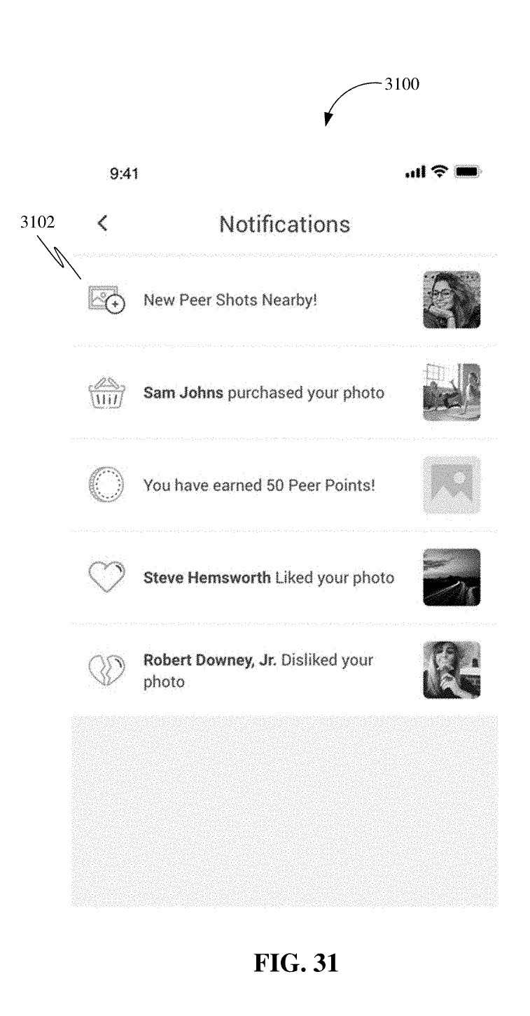

FIG. 31 is a snapshot of a user interface 3100 of a smartphone application, in accordance with an exemplary embodiment. Accordingly, the user interface 3100, in an instance, may allow a user to view a list of notifications 3102 associated with the user.

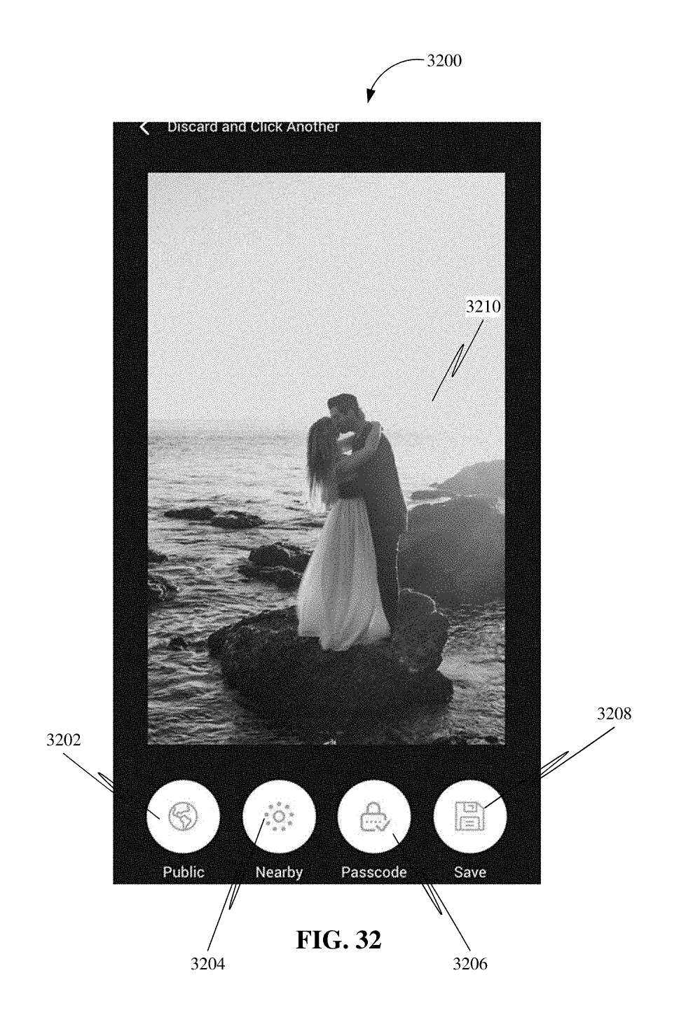

FIG. 32 is a snapshot of a user interface 3200 of a smartphone application, in accordance with an exemplary embodiment. Accordingly, the user interface 3200, in an instance, may allow a user to access a one or more options such as (but not limited to) Public 3202, Nearby 3204, Passcode 3206, and/or Save 3208. Further, the Public 3202, in an instance, may set a content (such as a picture 3210) as a public content. Further, the Nearby 3204, in an instance, may allow the user to share the content with other users that may be in locations nearby to the user. Further, the Passcode 3206, in an instance, may allow the user to generate a unique code associated with the content. Further, the Save 3208, in an instance, may allow the user to save the content to a database (such as databases 108) associated with the online platform 100.

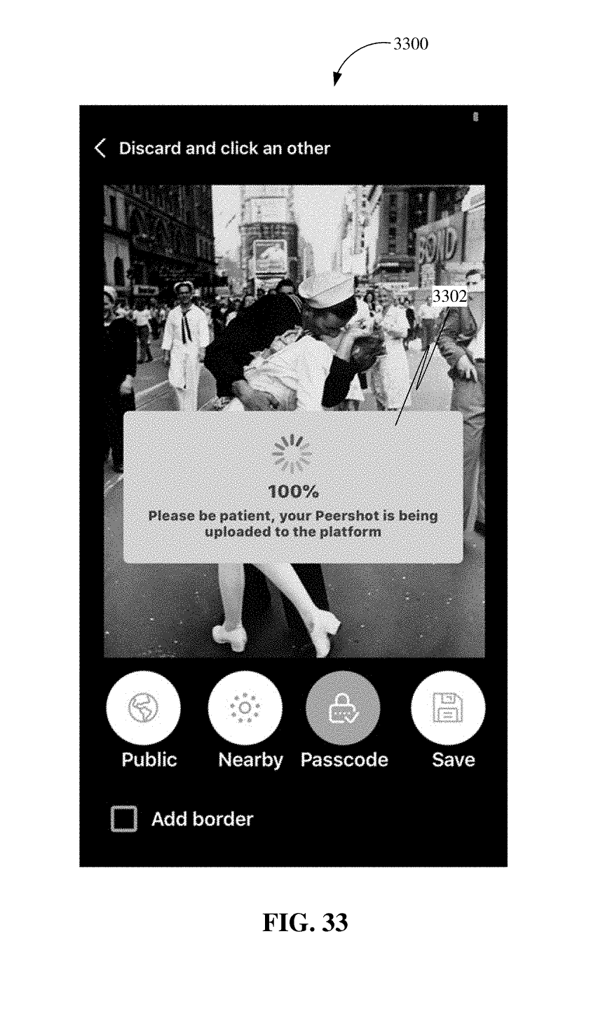

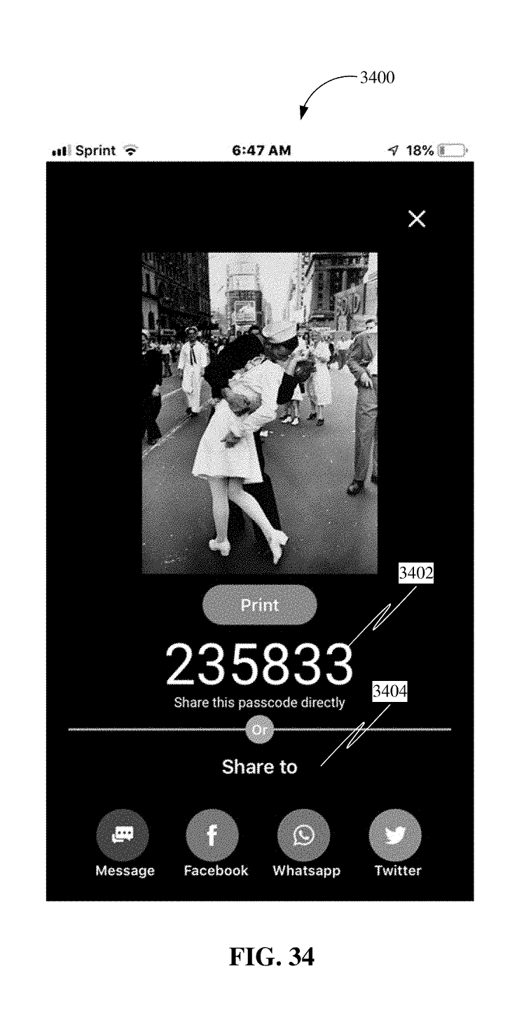

FIG. 33 is a snapshot of a user interface 3300 of a smartphone application, in accordance with an exemplary embodiment. Accordingly, the user interface 3300, in an instance, may display a notification 3302 in order to notify a user about upload status. FIG. 34 is a snapshot of a user interface 3400 of a smartphone application, in accordance with an exemplary embodiment. Accordingly, the user interface 3400, in an instance, may display a unique code 3402 (such as a six-digit passcode) that may be shared with other users over one or more platforms 3404 (such as, but not limited to, Message, Facebook®, WhatsApp®, Twitter® etc.).

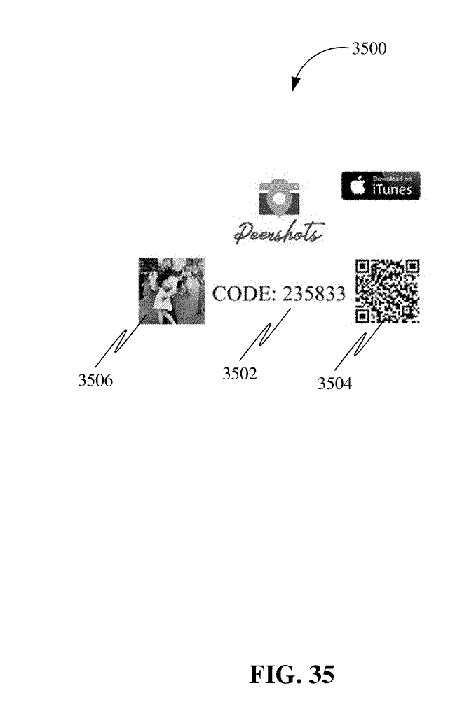

FIG. 35 is a snapshot of a user interface 3500 of a smartphone application, in accordance with an exemplary embodiment. Accordingly, the user interface 3500, in an instance, may display a unique code with digits (such as code 3502), and/or with a QR-code 3504 associated with content (such as a picture 3506).

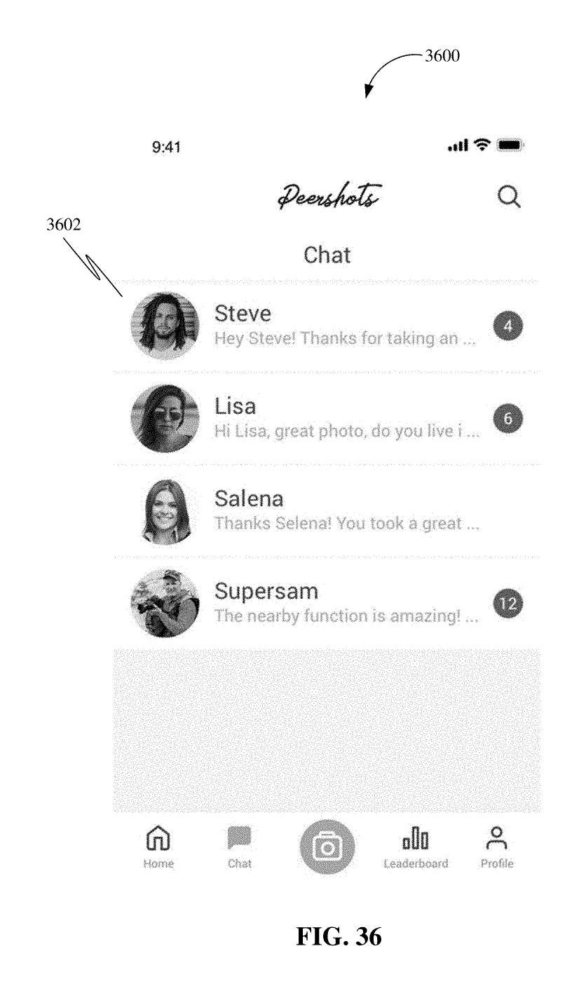

FIG. 36 is a snapshot of a user interface 3600 of a smartphone application, in accordance with an exemplary embodiment. Accordingly, the user interface 3600, in an instance, may allow a user to view a list 3602 of other users registered with the online platform 100 in order to chat with the other users.

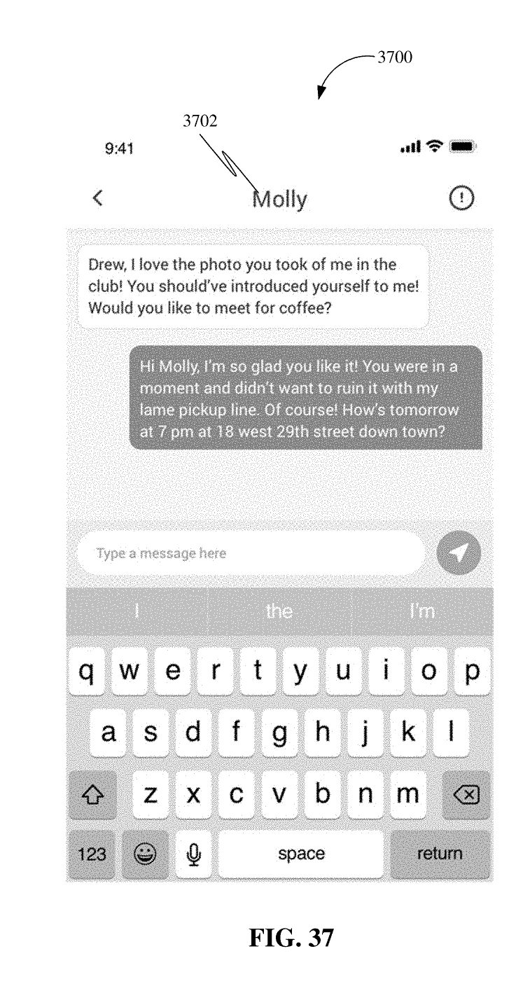

FIG. 37 is a snapshot of a user interface 3700 of a smartphone application, in accordance with an exemplary embodiment. Accordingly, the user interface 3700, in an instance, may allow a user to chat with other users (such as Molly 3702) registered with the online platform 100.

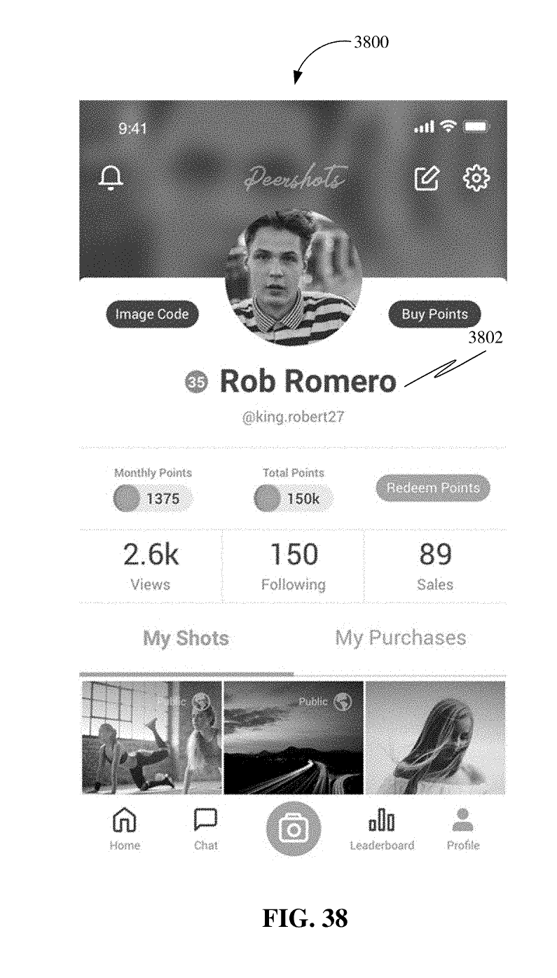

FIG. 38 is a snapshot of a user interface 3800 of a smartphone application, in accordance with an exemplary embodiment. Accordingly, the user interface 3800, in an instance, may display one or more information associated with a user profile of a user 3802 that may be using the smartphone application. Further, the one or more information, in an instance, may include information such as (but not limited to) name, views, followings, sales, photographs, total points etc.

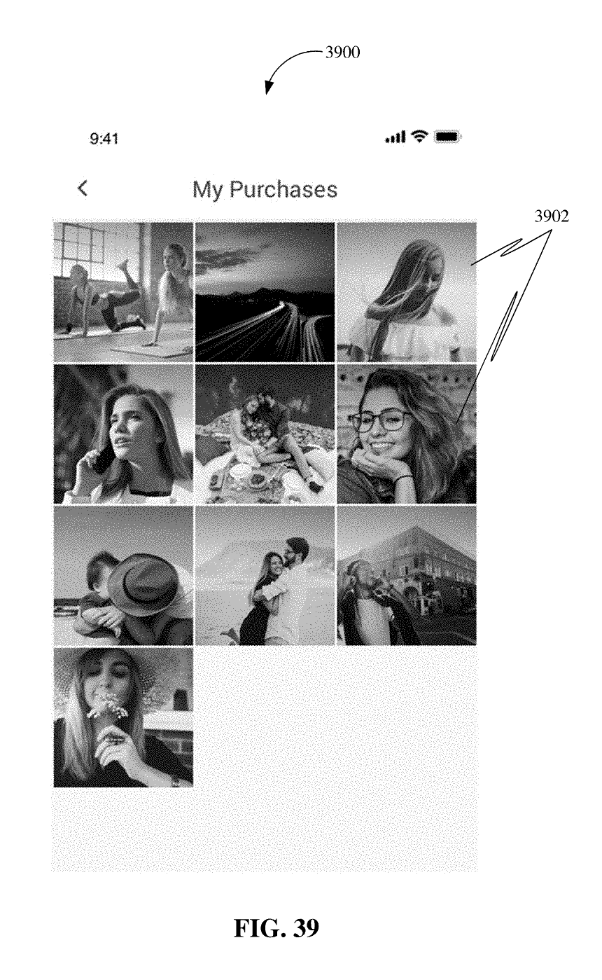

FIG. 39 is a snapshot of a user interface 3900 of a smartphone application, in accordance with an exemplary embodiment. Accordingly, the user interface 3900, in an instance, may allow the user to view a plurality of pictures 3902 that may be purchased by a user that may be using the smartphone application.

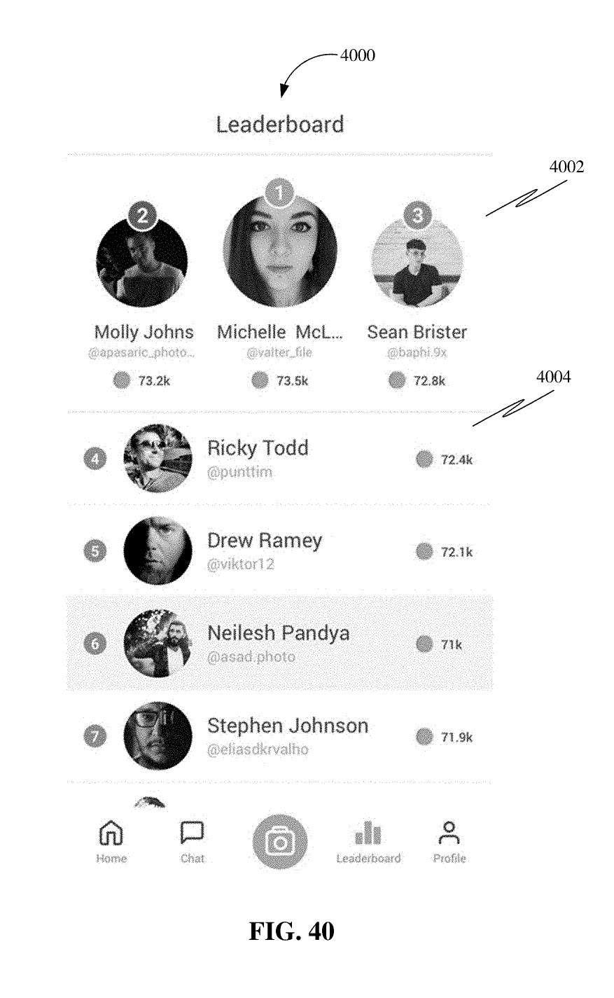

FIG. 40 is a snapshot of a user interface 4000 of a smartphone application, in accordance with an exemplary embodiment. Accordingly, the user interface 4000, in an instance, may allow a user to view a leaderboard. Further, the leaderboard, in an instance, may include two sections such as a top section 4002 and a list section 4004. Further, the top section 4002, in an instance, may show top three users with highest points. Further, the list section 4004, in an instance, may list the remaining users based on points associated with each user.

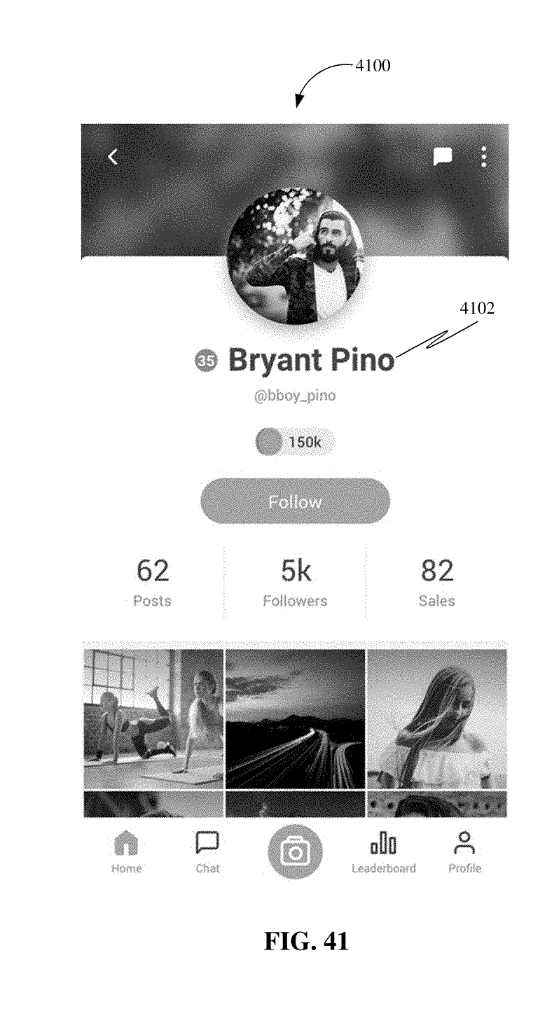

FIG. 41 is a snapshot of a user interface 4100 of a smartphone application, in accordance with an exemplary embodiment. Accordingly, the user interface 4100, in an instance, may display one or more information associated with a user profile of other user 4102 (such as other user named Bryant Pino) that may be registered with the online platform 100. Further, the one or more information, in an instance, may include information such as (but not limited to) name, posts, followers, sales, photographs, total points etc.

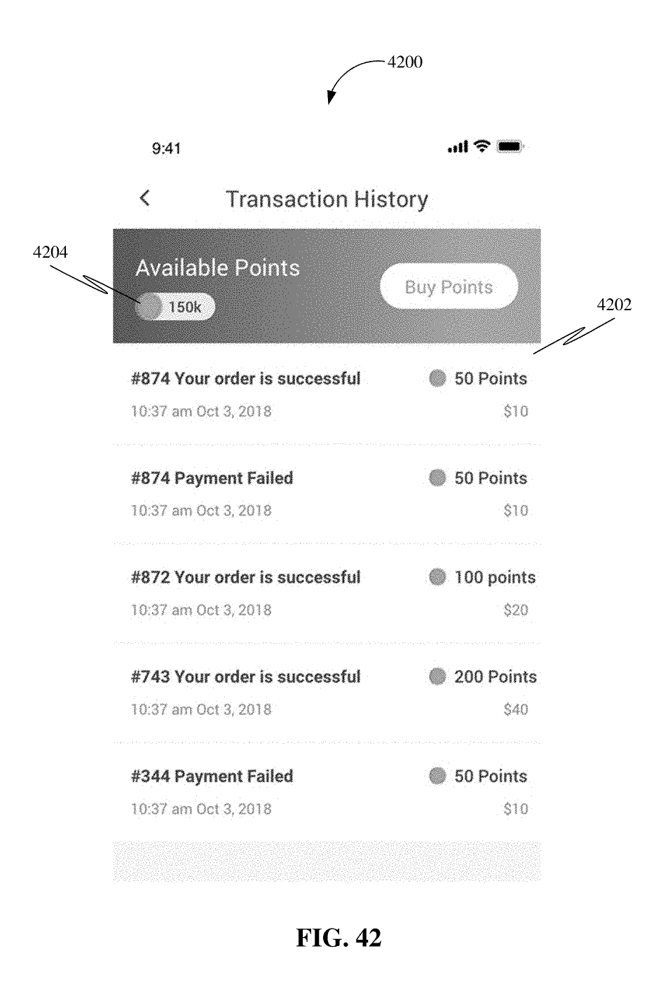

FIG. 42 is a snapshot of a user interface 4200 of a smartphone application, in accordance with an exemplary embodiment. Accordingly, the user interface 4200, in an instance, may allow a user to view a list of transaction history 4202 and/or available points 4204 associated with a user profile.

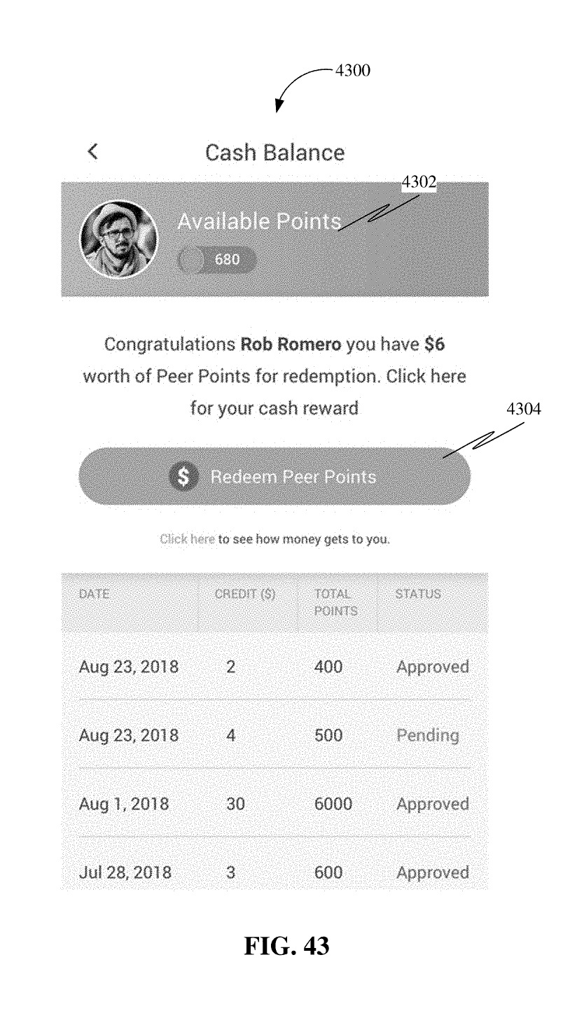

FIG. 43 is a snapshot of a user interface 4300 of a smartphone application, in accordance with an exemplary embodiment. Accordingly, the user interface 4300, in an instance, may allow a user to redeem real money (for instance in USD) from available points 4302. For instance, the user may tap on Redeem Peer Points 4304 in order to redeem real money from the available points 4302.

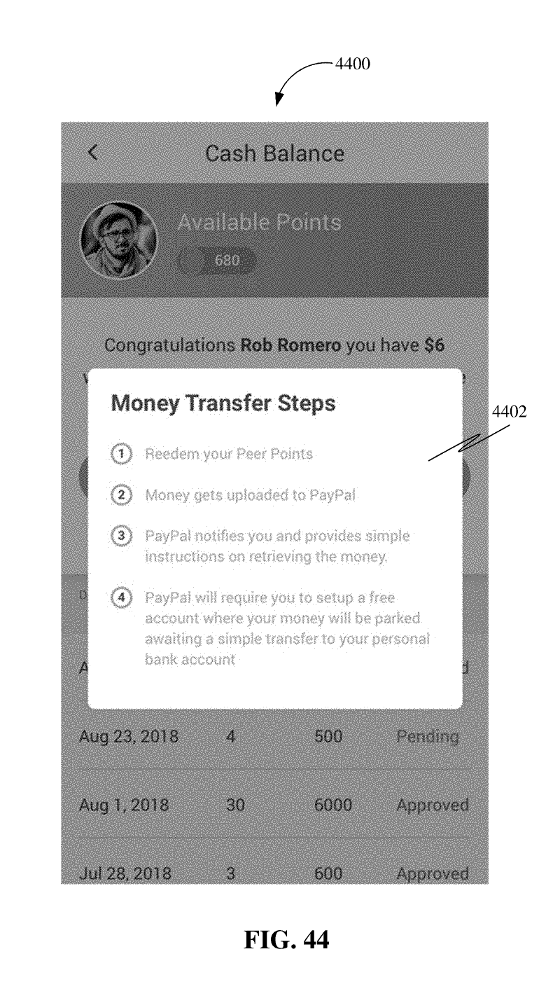

FIG. 44 is a snapshot of a user interface 4400 of a smartphone application, in accordance with an exemplary embodiment. Accordingly, the user interface 4400, in an instance, may allow a user to view a transfer-steps menu 4402 that may provide a step by step information to the user in order to redeem real cash money from available points.

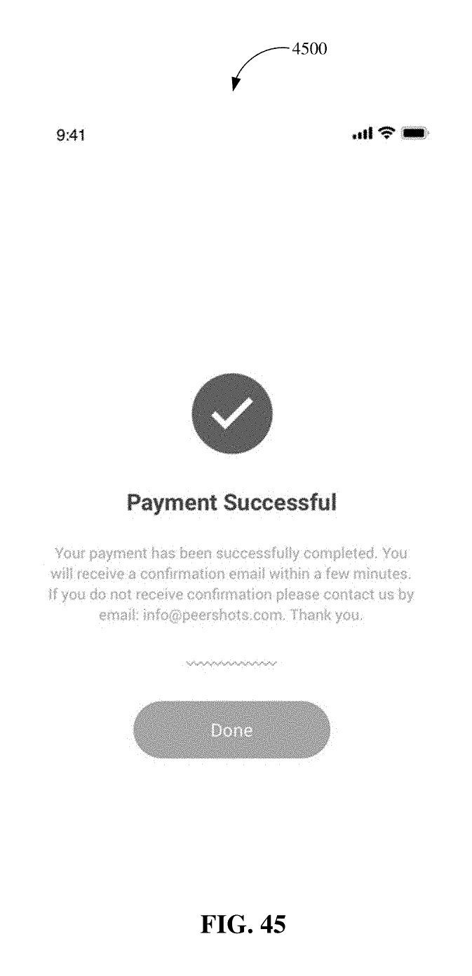

FIG. 45 is a snapshot of a user interface 4500 of a smartphone application, in accordance with an exemplary embodiment. Accordingly, the user interface 4500, in an instance, may notify a user about a transaction status (such as payment successful and/or failed) while redeeming real money from available points.

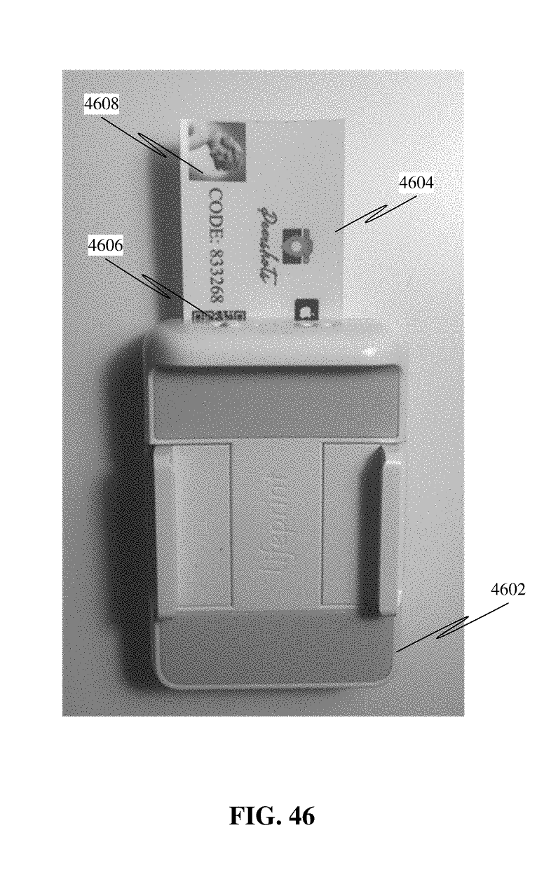

FIG. 46 shows a printer 4602 printing a physical card 4604, including a unique code 4606 corresponding to an image 4608, in accordance with some embodiments.

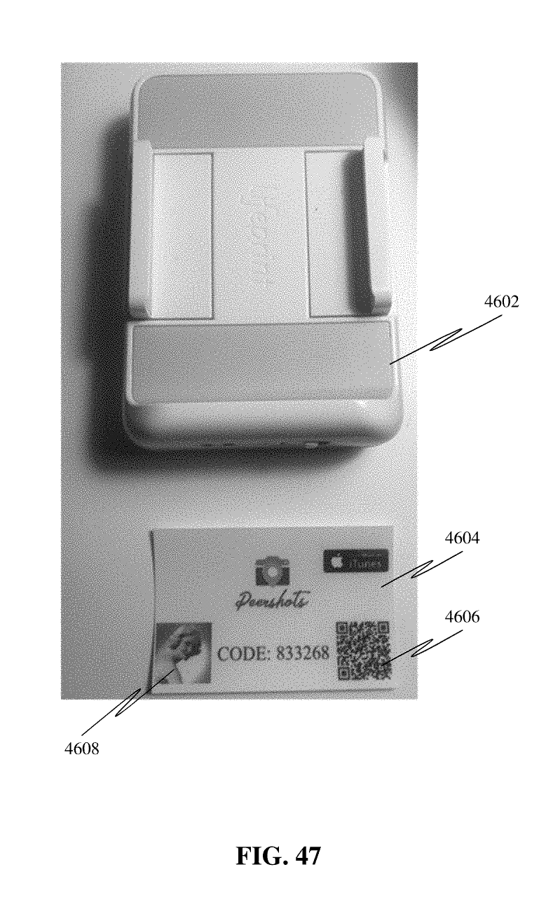

FIG. 47 shows the printer 4602, along with the physical card 4604, including the unique code 4606 corresponding to the image 4608, in accordance with some embodiments.

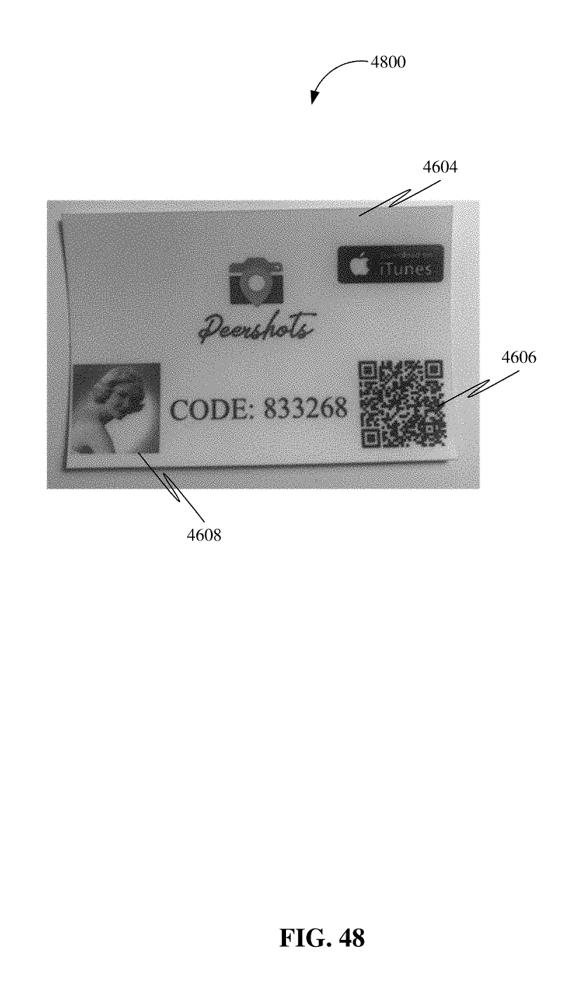

FIG. 48 shows a close up view 4800 of the physical card 4604, including the unique code 4606 corresponding to the image 4608, in accordance with some embodiments. Further, the unique code 4606 may be scanned, such as through a scanning device, a smartphone, and so on to access the image 4608.

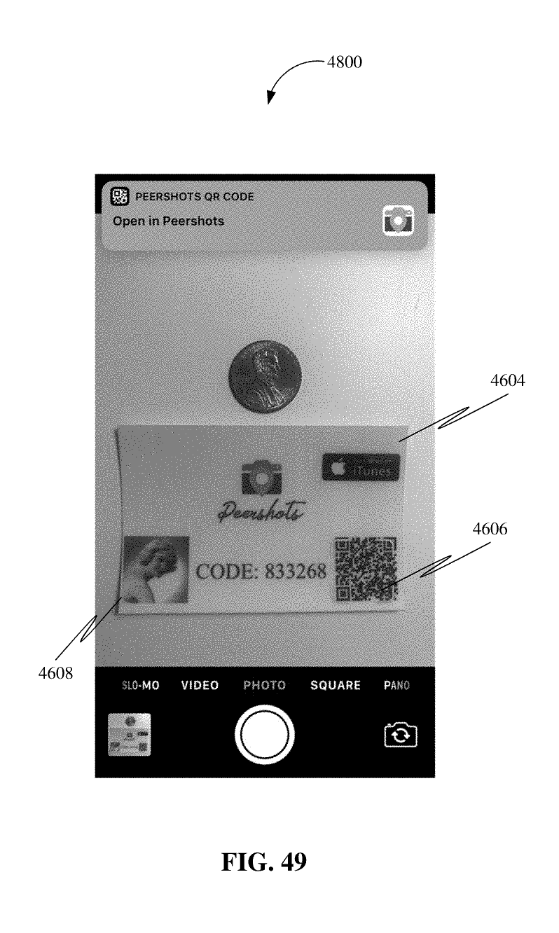

FIG. 49 is a snapshot of a user interface 4900 of a smartphone application to scan a unique code, such as the unique code 4606, in accordance with an exemplary embodiment. Further, the unique code 4606 on the physical card 4604 may be scanned to access the image 4608.

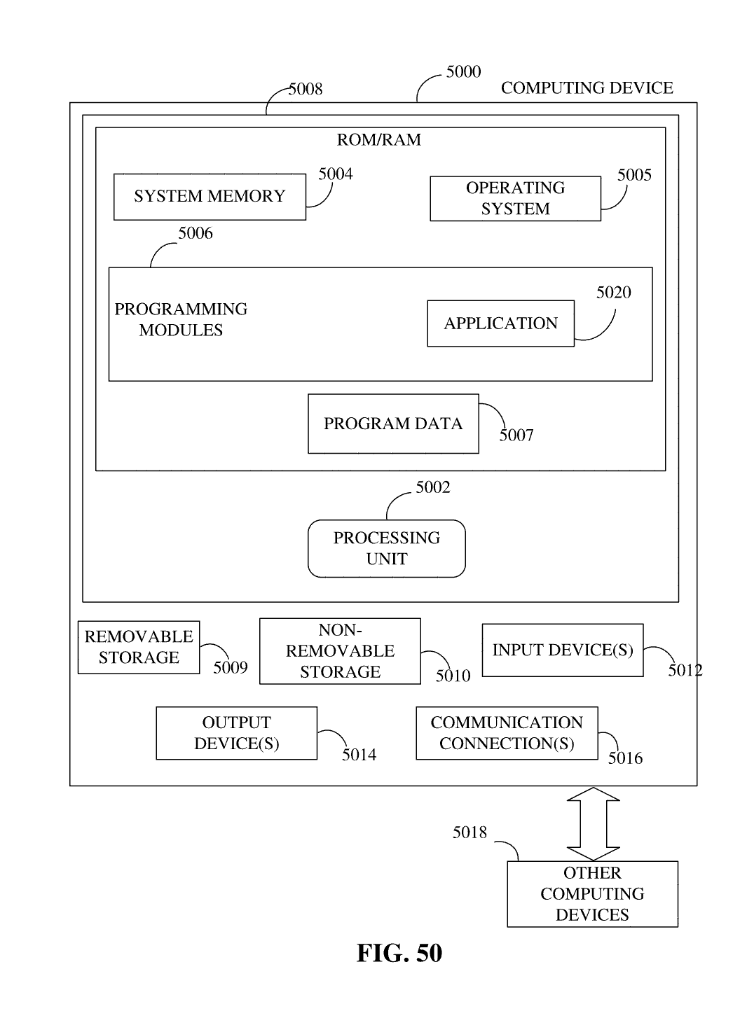

With reference to FIG. 50, a system consistent with an embodiment of the disclosure may include a computing device or cloud service, such as computing device 5000. In a basic configuration, computing device 5000 may include at least one processing unit 5002 and a system memory 5004. Depending on the configuration and type of computing device, system memory 5004 may comprise, but is not limited to, volatile (e.g. random-access memory (RAM)), non-volatile (e.g. read-only memory (ROM)), flash memory, or any combination. System memory 5004 may include operating system 5005, one or more programming modules 5006, and may include a program data 5007. Operating system 5005, for example, may be suitable for controlling computing device 5000's operation. In one embodiment, programming modules 5006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 50 by those components within a dashed line 5008.

Computing device 5000 may have additional features or functionality. For example, computing device 5000 may also include additional data storage devices (removable and/or non-removable) such as, for example, magnetic disks, optical disks, or tape. Such additional storage is illustrated in FIG. 50 by a removable storage 5009 and a non-removable storage 5010. Computer storage media may include volatile and non-volatile, removable and non-removable media implemented in any method or technology for storage of information, such as computer-readable instructions, data structures, program modules, or other data. System memory 5004, removable storage 5009, and non-removable storage 5010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 5000. Any such computer storage media may be part of device 5000. Computing device 5000 may also have input device(s) 5012 such as a keyboard, a mouse, a pen, a sound input device, a touch input device, a location sensor, a camera, a biometric sensor, etc. Output device(s) 5014 such as a display, speakers, a printer, etc. may also be included.

The aforementioned devices are examples and others may be used.

Computing device 5000 may also contain a communication connection 5016 that may allow device 5000 to communicate with other computing devices 5018, such as over a network in a distributed computing environment, for example, an intranet or the Internet. Communication connection 5016 is one example of communication media.

Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 5004, including operating system 5005. While executing on processing unit 5002, programming modules 5006 (e.g., application 5020 such as a media player) may perform processes including, for example, one or more stages of methods, algorithms, systems, applications, servers, databases as described above. The aforementioned process is an example, and processing unit 5002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating peer-to-peer sharing of at least one image, the method comprising:
receiving, using a communication device, the at least one image captured by a first user device along with an orientation and a location of the first user device;
receiving, using the communication device, a location of a second user device;
determining, using a processing device, a coverage area based on a field of view, the orientation and the location of the first user device;
matching, using the processing device, the coverage area with the location of the second user device; and
sending, using the communication device, a notification to the second user device based on the matching.

2. The method of claim 1, wherein the at least one image includes at least one of at least one still photo and a video.

3. The method of claim 1 further comprising generating, using the processing device, a unique code for the at least one image.

4. The method of claim 3 further comprising storing, using a storage device, the at least one image along with the unique code, geo-location of the first user device and a time stamp.

5. The method of claim 4 further comprising receiving, using the communication device, a search request related to the at least one image from a third party, wherein the search request includes one or more of a geo-location and a time stamp.

6. The method of claim 5 further comprising transmitting, using the communication device, the at least one image to the third party when the at least one image is marked public.

7. The method of claim 1 further comprising performing, using the processing device, image analysis on the at least one image, wherein the sending, using the communication device, of the notification to the second user device is further based on the image analysis.

8. The method of claim 1, wherein the sending the notification includes sending, using the communication device, the notification anonymously.

9. The method of claim 1, wherein the sending of the notification includes sending the notification, using the communication device, to a plurality of users.

10. The method of claim 1 further comprising receiving, using the communication device, a request from the second user device, wherein the request includes performing one or more of storing a caption along with the at least one image, sharing the at least one image with another user, making the at least one image public, sending message to the first user device, making a payment to purchase a print of the at least one image and deleting the at least one image.

11. A system of facilitating peer-to-peer sharing of at least one image, the system comprising:
a communication device configured to:
receive the at least one image captured by a first user device along with an orientation and a location of the first user device;
receive a location of a second user device;
send a notification to the second user device based on matching of a coverage area with the location of the second user device;
a processing device configured to:
determine the coverage area based on a field of view, the orientation and the location of the first user device; and
match the coverage area with the location of the second user device.

12. The system of claim 11, wherein the at least one image includes at least one of at least one still photo and a video.

13. The system of claim 11, wherein the processing device is further configured to generate a unique code for the at least one image.

14. The system of claim 13, wherein a storage device is configured to store the at least one image along with the unique code, geo-location of the first user device, and a time stamp.

15. The system of claim 14, wherein the communication device is further configured to receive a search request related to the at least one image from a third party, wherein the search request includes one or more of a geo-location and a time stamp.

16. The system of claim 15, wherein the communication device is further configured to transmit the at least one image to the third party when the at least one image is marked public.

17. The system of claim 11, wherein the processing device is further configured to perform image analysis on the at least one image, wherein the communication device is further configured to send the notification to the second user device based on the image analysis.

18. The system of claim 11, wherein the communication device is further configured to send the notification anonymously.

19. The system of claim 11, wherein the communication device is further configured to send the notification to a plurality of users.

20. The system of claim 11, wherein the communication device is further configured to receive a request from the second user device, wherein the request includes performing one or more of storing a caption along with the at least one image, sharing the at least one image with another user, making the at least one image public, sending message to the first user device, making a payment to purchase a print of the at least one image and deleting the at least one image.
